(19) United States
(12) Patent Application Publication
(10) Pub. No.: US 2025/0008401 A1
(43) Pub. Date: Jan. 2, 2025

(54) CANDIDATE CELL RECONFIGURATION OF DISTRIBUTED UNIT (DU) AND UE DUE TO INTRA-DU TO INTER-DU STATUS CHANGE

(71) Applicant: RAKUTEN SYMPHONY, INC, Setagaya-ku (JP)

(72) Inventor: Subramanya CHANDRASHEKAR, Karnataka (IN)

(21) Appl. No.: 18/681,859

(22) PCT Filed: Jan. 3, 2024
(86) PCT No.: PCT/US2024/010147

§ 371 Date: Feb. 7, 2024

(30) Foreign Application Priority Data
Mar. 3, 2023 (IN) 202321014282
Oct. 31, 2023 (IN) 202321014282

(51) Int. Cl. H04W 36/08; H04W 36/00

(52) U.S. Cl. CPC H04W 36/087; H04W 36/0058

(57) ABSTRACT

Embodiments of the present disclosure disclose handling of candidate cell reconfiguration of serving/candidate Distributed Unit (DU) and User Equipment (UE) due to intra-DU to inter-DU status change. In an embodiment, Centralized Unit (CU) receives notification indicating change in serving cell due to L1/L2 triggered mobility (LTM) for UE. Further, CU determines status change of one or more cells of serving DU and one or more candidate/target cells of candidate/target DU amongst plurality of candidate/target DU upon changing serving cell for UE to new serving cell. Thereafter, CU sends message comprising status change information of all candidate/target cells including their corresponding cell identifiers to new serving DU. Finally, CU receives confirmation of reconfiguration corresponding to status change at new serving DU and UE. UE applies one or more configuration changes provided by CU prior to change in serving cell. The present disclosure provides advantage of reducing latency during LTM of UE.

### TECHNICAL FIELD

The present disclosure generally relates to handling candidate cell reconfiguration of candidate/serving Distributed Unit (DU) and User Equipment (UE) due to intra-DU to inter-DU status change.

### BACKGROUND

In general, a disaggregated architecture is defined in 3rd Generation Partnership Project (3GPP) decomposing a Next Generation Node B (gNB) into multiple logical entities. Likewise, a single Distributed Unit (DU) may host multiple cells (max of 512 in current 3GPP specifications). The gNB-Control Unit-Control Plane (CU-CP) hosts Packet Data Convergence Protocol (PDCP) layer and Radio Resource Control (RRC) layer, while the DU hosts Radio link control (RLC), Medium Access Control (MAC) and PHY layers. Scheduling operations takes place at the DU. In order to support L1/L2 centric inter-cell change (i.e. change of serving cell) in the disaggregated gNB architecture, a new mechanism is needed in which configuration would be performed by the Centralized Unit (CU) (or gNB CU-CP), but executed autonomously by the DU without further interaction with the upper layers.

In existing literature, sequential or subsequent L1/L2 Serving Cell Change (SCC) between candidates without additional RRC reconfiguration is supported. Therefore, if multiple LTM candidate cells are configured for a User Equipment (UE), an L1/L2 triggered mobility (LTM) serving cell change need not compulsively imply an RRC re-configuration for the remaining LTM candidate cells (as in Conditional HO). A subsequent sequential LTM SCC can be executed without RRC reconfiguration as well. Consider an exemplary scenario in which, a gNB has two DU controlled by a CU and each DU may include 4 cells in each. For example, cells 1, 2, 3, 4 belong to DU1 and 5, 6, 7, 8 belong to DU2. Also, the UE has its serving cell in cell 2 and is configured with LTM candidate cells from both DU, for example: 3, 4, 5, 6. In this case, the status of the cells may be:
Cell 2—Serving cell (DU1)
Cells 3, 4 5—intra DU candidate cells
Cells 5, 6—inter DU candidate cells

There are two main scenarios: i) intra-DU LTM SCC and ii) inter-DU LTM SCC. During intra-DU LTM SCC: If the above UE undergoes an intra DU LTM SCC. For example from Cell2 to Cell 3, the scenario does not change much, except losing one candidate cell (in case, serving cell 2 is not automatically configured as a candidate cell). The status of the cells may be:
Cell 3—Serving cell (DU1)
Cells 4—intra DU candidate cell
Cells 5, 6—inter DU candidate cells

If the above UE undergoes an inter DU LTM SCC, for example: from Cell2 to Cell 5, the scenario changes considerably. (in case, ex-serving cell 2 is not automatically configured as a candidate cell). The status of the cells may be:
Cell 5—Serving cell (DU5).
Cells 3, 4—Inter DU candidate cells
Cells 6—Intra DU candidate cells

There is no impact in the intra-DU LTM SCC. However, in inter-DU LTM SCC, the intra DU candidate cells have become inter DU candidate cells and vice versa. There are several aspects in LTM which are different for the intra DU and the inter DU candidate cells. The re-configuration is needed when the intra DU candidate cells are changed to the inter-DU candidate cells and vice versa also. Thus, it is desired to address the above-mentioned disadvantages or other shortcomings or at least provide a useful alternative to ensure subsequent LTM SCC without additional RRC re-configurations.

The information disclosed in this background of the disclosure section is only for enhancement of understanding of the general background of the invention and should not be taken as an acknowledgement or any form of suggestion that this information forms the prior art already known to a person skilled in the art.

### SUMMARY

In L1/L2 triggered mobility (LTM), cell change between candidates without RRC reconfiguration should be supported. This implies that, assuming multiple LTM candidate cells configured for UE, an LTM Serving Cell Change (SCC) should not compulsively imply an RRC re-configuration for the remaining LTM candidate cells. A subsequent sequential LTM SCC can be executed without RRC reconfiguration as well. In other words, the LTM SCC without RRC reconfiguration of remaining LTM candidate cells is challenging in case of an inter-DU LTM SCC.

In an embodiment, a Centralized Unit (CU) of a Next Generation Radio Access Network (NG-RAN) for handling of candidate cell reconfiguration of serving/candidate Distributed Unit (DU) and User Equipment (UE) due to intra-DU to inter-DU status change is disclosed. The CU comprises a processor and a memory. The memory is communicatively coupled to the processor and stores processor-executable instructions, which on execution, cause the processor to receive a notification indicating a change in serving cell due to L1/L2 triggered mobility (LTM) for a UE, from a serving DU of the UE in the NG-RAN. Further, the processor determines a status change of one or more cells of the serving DU and one or more candidate/target cells of a candidate/target DU amongst a plurality of candidate/target DU upon changing the serving cell for the UE to a new serving cell. The new serving cell is one of the one or more candidate/target cells of a candidate/target DU. Thereafter, the processor sends a message comprising the status change information of all the candidate/target cells including their corresponding cell identifiers to the new serving DU. Content of the message is further transmitted to the UE by the new serving DU. Finally, the processor receives a confirmation of reconfiguration corresponding to the status change at the new serving DU and the UE. The UE applies one or more configuration changes provided by the CU prior to the change in the serving cell, as part of the reconfiguration.

In another embodiment, a method for handling of candidate cell reconfiguration of serving/candidate Distributed Unit (DU) and User Equipment (UE) due to intra-DU to inter-DU status change is disclosed. The method includes receiving, by a Centralized Unit (CU) of a Next Generation Radio Access Network (NG-RAN node), a notification indicating a change in serving cell due to L1/L2 triggered mobility (LTM) for a UE, from a serving DU of the UE in the NG-RAN. Further, the method comprises determining a status change of one or more cells of the serving DU and one or more candidate/target cells of a candidate/target DU amongst a plurality of candidate/target DU upon changing the serving cell for the UE to a new serving cell. The new serving cell is one of the one or more candidate/target cells of a candidate/target DU. Thereafter, the method comprises sending a message comprising the status change information of all the candidate/target cells including their corresponding cell identifiers to the new serving DU. Content of the message is further transmitted to the UE by the new serving DU. Finally, the method comprises receiving a confirmation of reconfiguration corresponding to the status change at the new serving DU and the UE. The UE applies one or more configuration changes provided by the CU prior to the change in the serving cell, as part of the reconfiguration.

In yet another embodiment, a non-transitory computer readable medium including instructions stored thereon that when processed by at least one processor, cause a Centralized Unit (CU) of a Next Generation Radio Access Network (NG-RAN) to perform operations comprising receiving a notification indicating a change in serving cell due to L1/L2 triggered mobility (LTM) for a UE, from a serving Distributed Unit (DU) of the UE in the NG-RAN. Further, the instructions cause the processor to determine a status change of one or more cells of the serving DU and one or more candidate/target cells of a candidate/target DU amongst a plurality of candidate/target DU upon changing the serving cell for the UE to a new serving cell. The new serving cell is one of the one or more candidate/target cells of a candidate/target DU. Thereafter, the instructions cause the processor to send a message comprising the status change information of all the candidate/target cells including their corresponding cell identifiers to the new serving DU. Content of the message is further transmitted to the UE by the new serving DU. Finally, the instructions cause the processor to receive a confirmation of reconfiguration corresponding to the status change at the new serving DU and the UE. The UE applies one or more configuration changes provided by the CU prior to the change in the serving cell, as part of the reconfiguration.

In an embodiment, a User Equipment (UE) for handling of candidate cell reconfiguration of serving/candidate Distributed Unit (DU) and the UE due to intra-DU to inter-DU status change is disclosed. The UE comprises a processor and a memory. The memory is communicatively coupled to the processor and stores processor-executable instructions, which on execution, cause the processor to receive a notification indicating change in a serving cell, from a serving Distributed Unit (DU) of a Next Generation Radio Access Network (NG-RAN). Further, the processor establishes a connection with a new serving cell of a new serving DU. The UE confirms the application of new serving cell configuration to Centralized Unit (CU) of the RAN upon establishing a successful connection with the new serving cell. Thereafter, the processor receives a message comprising status change of a one or more candidate/target cells of the new serving DU and all the candidate/target DU from the CU through the new serving DU, when the serving cell for the UE is changed to the new serving cell of the new serving DU. Finally, the processor performs one or more configuration changes corresponding to the status change as part of reconfiguration, and sends a confirmation of the reconfiguration to the CU. The one or more configuration changes are received from the CU prior to the change in the serving cell.

In another embodiment, a method for handling of candidate cell reconfiguration of serving/candidate Distributed Unit (DU) and User Equipment (UE) due to intra-DU to inter-DU status change is disclosed. The method includes receiving, by a User Equipment (UE), a notification indicating change in a serving cell, from a serving Distributed Unit (DU) of a Next Generation Radio Access Network (NG-RAN). Further, the method comprises establishing a connection with a new serving cell of a new serving DU. The UE confirms the application of new serving cell configuration to Centralized Unit (CU) of the RAN upon establishing a successful connection with the new serving cell. Thereafter, the method comprises receiving a message comprising status change of one or more candidate/target cells of the new serving DU and all the candidate/target DU from the CU through the new serving DU, when the serving cell for the UE is changed to the new serving cell of the new serving DU. Finally, the method comprises performing one or more configuration changes corresponding to the status change as part of reconfiguration, and sending a confirmation of the reconfiguration to the CU. The one or more configuration changes are received from the CU prior to the change in the serving cell.

In yet another embodiment, a non-transitory computer readable medium including instructions stored thereon that when processed by at least one processor, cause a User Equipment (UE) to perform operations comprising receiving a notification indicating change in a serving cell, from a serving Distributed Unit (DU) of a Next Generation Radio Access Network (NG-RAN). Further, the instructions cause the processor to establishes a connection with a new serving cell of a new serving DU. The UE confirms the application of new serving cell configuration to Centralized Unit (CU) of the RAN upon establishing a successful connection with the new serving cell. Thereafter, the instructions cause the processor to receive a message comprising status change of a one or more candidate/target cells of the new serving DU and all the candidate/target DU from the CU through the new serving DU, when the serving cell for the UE is changed to the new serving cell of the new serving DU. Finally, the instructions cause the processor to perform one or more configuration changes corresponding to the status change as part of reconfiguration, and send a confirmation of the reconfiguration to the CU. The one or more configuration changes are received from the CU prior to the change in the serving cell.

In an embodiment, a new serving Distributed Unit (DU) for handling of candidate cell reconfiguration of serving/candidate Distributed Unit (DU) and User Equipment (UE) due to intra-DU to inter-DU status change is disclosed. The new serving DU comprises a processor and a memory. The memory is communicatively coupled to the processor and stores processor-executable instructions, which on execution, cause the processor to receive a connection establishment from a UE after changing a serving cell to a new serving cell belonging to a new serving DU. Further, the processor receives a message comprising status change of a one or more of cells of the candidate/target DU and the new serving DU, from the CU, when the serving cell for the UE is changed to the new serving cell, and transmitting the content of the message from the CU to the UE using Layer 1 or Layer 2 message. Finally, the processor performs reconfiguration of the new serving DU based on the status change and sending a confirmation of the reconfiguration to the CU.

In another embodiment, a method for handling of candidate cell reconfiguration of serving/candidate Distributed Unit (DU) and User Equipment (UE) due to intra-DU to inter-DU status change is disclosed. The method includes receiving, by a new serving DU, a connection establishment from a UE after changing a serving cell to a new serving cell belonging to a new serving DU. Further, the method comprises receiving a message comprising status change of a one or more of candidate/target cells of the candidate/target DU and the new serving DU, from the CU, when the serving cell for the UE is changed to the new serving cell, and transmitting content of the message from the CU to the UE using Layer 1 or Layer 2 message. Finally, the method comprises performing reconfiguration of the new serving DU based on the status change and sending a confirmation of the reconfiguration to the CU.

In yet another embodiment, a non-transitory computer readable medium including instructions stored thereon that when processed by at least one processor, cause a new serving Distributed Unit (DU) to perform operations comprising receiving a connection establishment from a User Equipment (UE) after changing a serving cell to a new serving cell belonging to a new serving DU. Further, the instructions cause the processor to receive a message comprising status change of a one or more of cells of the candidate/target DU and the new serving DU, from the CU, when the serving cell for the UE is changed to the new serving cell, and transmitting content of the message from the CU to the UE using a Layer 1 message or a Layer 2 message. Finally, the instructions cause the processor to perform reconfiguration of the new serving DU based on the status change and sending a confirmation of the reconfiguration to the CU.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1 shows an exemplary disaggregated Next Generation Node B (gNB) architecture, in accordance with some embodiments of the present disclosure;

FIG. 2A shows a detailed block diagram of a Control System (CU), in accordance with some embodiments of the present disclosure;

FIG. 2B shows a detailed block diagram of a User Equipment (UE), in accordance with some embodiments of the present disclosure;

FIG. 2C shows a detailed block diagram of a Distributed Unit (DU), in accordance with some embodiments of the present disclosure;

FIG. 3A shows an exemplary call flow diagram illustrating handling of candidate cell reconfiguration of serving/candidate Distributed Unit (DU) and User Equipment (UE) due to intra-DU to inter-DU status change, in accordance with some embodiments of the present disclosure;

FIG. 3B shows an exemplary call flow diagram illustrating broadcasting of status change to one or more candidate Distributed Units (DUs), in accordance with some embodiments of the present disclosure;

FIGS. 3C and 3D shows an exemplary scenario illustrating change of serving cell for a User Equipment (UE), in accordance with some embodiments of the present disclosure;

FIGS. 4A-4C shows a flowchart illustrating a method of handling of candidate cell reconfiguration of serving/candidate Distributed Unit (DU) and User Equipment (UE) due to intra-DU to inter-DU status change, in accordance with some embodiments of the present disclosure; and

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the specific forms disclosed, but on the contrary, the disclosure is to cover all modifications, equivalents, and alternative falling within the scope of the disclosure.

The terms “comprises”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

It shall be noted that, for convenience of explanation, the disclosure uses terms and names defined in the 3rd Generation Partnership Project Radio Access Network (3GPP RAN) standards. More specifically, the terms ‘Centralized Unit (CU)’, ‘Distributed Unit (DU)’, ‘Core Network’, ‘Packet Data Convergence Protocol (PDCP)’, ‘Radio Resource Control (RRC)’, ‘Radio Resource Control (RRC) configuration message’, ‘L1/L2 triggered mobility (LTM)’ and ‘Serving Cell Change (SCC)’ are to be interpreted as specified by the 3GPP RAN standards.

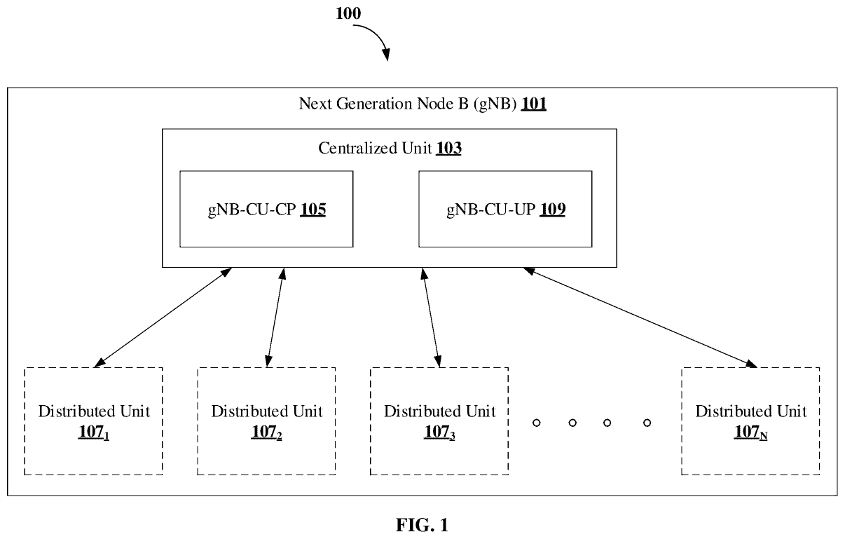

FIG. 1 shows an exemplary disaggregated Next Generation Node B (gNB) architecture, in accordance with some embodiments of the present disclosure.

Exemplary architecture 100 illustrates a disaggregated Next Generation Node B (gNB) 101 architecture. The disaggregated gNB 101 may be a base station which supports 5G New Radio (NR). The gNB 101 may be a Next Generation Radio Access Network (NG-RAN). In an embodiment, each gNB 101 may include multiple logical entities such as a Centralized Unit (CU) 103 and a Distributed Unit (DU) 107₁ to DU 107_{N} (also referred as a plurality of DUs 107_{N}). The CU 103 may include a gNB-Control Unit-Control Plane (CU-CP) 105 and one or more gNB-Control Unit-User Plane (CU-UP) 109. The CU-CP 105 may host Packet Data Convergence Protocol (PDCP) layers and Radio Resource Control (RRC) layers. Each of the plurality of DUs 107_{N} may host one or more cells. Each cell in the one or more cells may refer to a defined coverage area provided to a User Equipment (UE) (not shown in figures). Further, each DU in the plurality of DUs 107_{N} may host Radio link control (RLC), Medium Access Control (MAC) and PHY layers. In an embodiment, when the UE is connected with the network, the UE may be served by a cell of the DU. As an example, the UE may include, without limitation, any device used by a user to at least one of communicate and access content such as, but not limited to, mobile phones, smartphones, laptops, wearables and Internet of Things (IoTs). The UE may be connected to the gNB 101 using a communication network. As an example, the communication network may be 5^{th} Generation (5G) network. The cell to which the UE is currently connected with may be referred to as a serving cell as the cell is currently serving the UE. In an embodiment, during mobility of the UE, the serving cell for the UE may change based on the serving area of the UE. In other words, as the serving area of each cell is defined, the serving cell may change if the UE is in motion. The UE must be connected to the next cell to ensure that the UE receives the services continuously and does not suffer interruptions. This is also known as subsequent mobility of the UE or handover of the UE.

In an embodiment, the CU 103 may be configured to receive a notification indicating a change in serving cell due to L1/L2 triggered mobility (LTM) for the UE, from the serving DU of the UE in the NG-RAN. The UE may be served by a cell in the DU, this cell may be referred as the serving cell and the DU which hosts the serving cell may be the serving DU. The LTM for the UE relates to handover of the UE to a new serving cell when, without limitation, the signal quality received by the UE deteriorates or mobility of the UE. In an embodiment, prior to receiving the notification, the CU 103 may detect one or more candidate/target DUs among plurality of DUs 107_{N} based on a first measurement report received from the UE. Each of the one or more candidate/target DUs may host one or more candidate/target cells. In an embodiment, the target DU may be a new serving DU among the one or more candidate DUs. The first measurement report may be Radio Resource Control (RRC) (L3) measurements report received by the CU 103 from the UE. As an example, the Layer 3 (L3) measurement report may include, without limitation, signal strength of the UE, quality of the UE signal and location of the UE. Based on the received first measurement report, the CU 103 may determine that there may be a need for handover as the UE is moving (mobility of the UE). Upon detecting one or more candidate/target DUs among a plurality of DUs 107_{N}, the CU 103 may transmit a setup request or a modification request, requesting preparation of a LTM target cell configuration, to each of the one or more candidate/target DUs detected based on the first measurement report. As an example, the setup request may be UE ContextSetupRequest( ) sent using an F1 interface. As an example, the modification request may be UE ContextModificationRequest( ) sent using an F1 interface. The F1 interface may be an interface between the CU 103 and the plurality of DUs 107_{N}. In some embodiments, the modification request may be transmitted using any other interface between the CU 103 and the plurality of DUs 107_{N}. The modification request received from the CU 103 may indicate a requirement of change of serving cell for the UE. Upon receiving the modification request, the serving DU may perform the predefined modification operations and transmit a confirmation to the CU 103 upon performing the modification. As an example, the confirmation may be UE contextModificationResponse( ) sent using an F1 interface. The setup request may be transmitted to each of the one or more candidate/target DUs, to prepare the one or more candidate cells in their respective DU. The one or more candidate/target DUs setup the one or more cells in the respective DU to establish connection with the UE. Upon performing context setup, the one or more candidate/target DUs may respond to the setup request by transmitting a response to the CU 103. Thereafter, the CU 103 transmits the one or more configuration changes corresponding to the status change to be performed by the UE as part of the reconfiguration to the serving DU. As an example, the one or more configuration changes may be, without limitation, changes related to MAC reset, RLC re-establishment and PDCP recovery. In an embodiment, the one or more configuration changes may be transmitted as a Downlink (DL) RRC message transfer to the serving DU. As an example, the one or more configuration changes may be transmitted as “DL RRC Message transfer (RRC Reconfiguration (LTM target cell configuration, Recon if for intra-DS↔inter-DS changes))” in a container using F1 interface. The serving DU may transmit the one or more configurations to the UE. As an example, the one or more configurations to the UE may be transmitted as “RRC Reconfiguration (LTM target cell configuration, Recon if for intra-DS↔inter-DS changes))”.

In an embodiment, the UE stores the one or more configurations and reconfigures based on the one or more configurations when required. In an embodiment, the UE transmits a second measurement report to the serving DU periodically or based on occurrence of one or more events. As an example, the one or more events may be without limitation, when the UE connects with the network for first time, during handover of the UE and when the serving DU requests the measurement report from the UE. The serving DU may determine the new serving cell for the UE based on the second measurement report. As an example, the second measurement report may be an intra-frequency Layer 1 (L1) measurement report or an inter-frequency L1 measurement report. The new serving cell may be target cell among one or more candidate cells. Based on the second measurement report, the serving DU may determine the new serving cell of the new serving DU for the UE. As an example, the serving DU may determine if the LTM HO radio condition is satisfied by any candidate/target cell in the one or more candidate/target DUs. Thereafter, the serving DU sends a notification indicating change in the serving cell to the UE. As an example, the notification may be sent to the UE as “MAC Control Element (CE) Serving Cell Change (SCC)”. To establish the connection with the new serving cell of the new serving DU, the UE may establish a connection with the new serving DU. As an example, the UE may transmit a connection establishment request, the connection establishment request may be Random Access Channel (RACH (Preamble)) to the new serving DU to establish the connection. Once the connection is established, the UE indicates the change in the serving cell to the CU 103 by sending an RRC Reconfiguration Acknowledgement ( ) The serving DU may also transmit the notification to the CU 103 indicating the change in serving cell for the UE. The notification may include a cell Identification (ID) of the new serving cell.

In an embodiment, upon receiving the notification, the CU 103 may be configured to determine a status change of one or more cells of the serving DU and one or more candidate/target cells of the candidate/target DU amongst a plurality of candidate/target DU upon changing the serving cell for the UE to the new serving cell. In an embodiment, the CU 103 may determine a change in state of each of the one or more cells of the serving DU and each of the one or more candidate/target cells of the candidate/target DU from intra-DU to inter-DU or inter-DU to intra-DU, based on the change in the UE's serving cell. In an embodiment, when the new serving cell is in the different DU other than the serving DU, then as the DU has been changed, this may be intra-DU to inter DU change. In other words, the status of the cells in the serving DU is changed to intra-DU from inter-DU as the new serving cell is not hosted in the serving DU. Consider an exemplary scenario in which a gNB has two DUs (DU1 and DU2) controlled by a CU 103 and each DU may host four cells each. For example, cells 1, 2, 3, 4 belong to DU1 and 5, 6, 7, 8 belong to DU2. Also, Currently the serving cell for the UE is cell 2 and the one or more candidate cells are cells 3, 4, 5 and 6. The status of each cell is shown below:
Cell 2—Serving cell (DU1)
Cells 3, 4—intra-DS candidate cells
Cells 5, 6—inter-DS candidate cells

Consider a scenario in which the serving DU undergoes inter-DS serving cell change, i.e., the serving DU determines the new serving cell in DU2. Assuming the new serving cell is cell 5 in DU2. The status of one or more cells in the serving DU and the new serving DU is changed due to inter-DS serving cell change. The status of each cell changed due to change in serving cell shown below:
Cell 5—Serving cell (DU2)
Cells 3, 4—inter-DS candidate cells
Cells 6—intra-DS candidate cells

The above shown changes may be determined by the CU 103 upon receiving the cell ID of the new serving cell from the serving DU.

In an embodiment, upon determining the status change, the CU 103 may be configured to send a message comprising the status change information of all the candidate/target cells including their corresponding cell identifiers to the new serving DU. As an example, the message may be sent to the new serving DU as a contextModificationRequest(updated intra DU↔interDU change list). The message may be sent to the new serving DU using the F1 interface. Upon receiving the message, the new serving DU may perform reconfiguration of the new serving DU based on the status change. In an embodiment, the UE receives content of the message comprising status change of the one or more cells of the serving DU and the new serving DU from the CU 103 through the new serving DU, when the serving cell for the UE is changed to the new serving cell of the new serving DU. As an example, the message may be “DL MAC CE (intra-DS↔inter-DS change list)”. After receiving the message, the new serving DU may perform the one or more configuration changes corresponding to the status change as part of reconfiguration. The new serving DU may receive the one or more configuration changes from the CU 103 prior to the change in the serving cell. As an example, the one or more configuration changes may be, without limitation, turning ON/OFF RLC re-establishment, turning ON/OFF PDCP recovery and turning ON/OFF partial MAC reset.

In some embodiments, the CU 103 may be configured to broadcast the serving cell change notification message to each of one or more candidate/target DUs detected by the CU 103 based on a first measurement report received from the UE. As an example, the message may be sent to the one or more candidate/target DUs as a contextModificationRequest (updated intra DU↔interDU change list). Upon receiving the message the one or more candidate/target DUs may perform the re-configuration. When the message is broadcasted, each of the one or more candidate/target DUs perform the re-configuration including the new serving DU. Once the re-configuration is completed, the CU 103 receives the reconfiguration information corresponding to the status change for each of the candidate/target cells, from each of the one or more candidate/target DUs.

In an embodiment, upon sending the message, the CU 103 may be configured to receive a confirmation of reconfiguration corresponding to the status change at the new serving DU and the UE. As discussed above, the UE applies the one or more configuration changes provided by the CU 103 prior to the change in the serving cell, as part of the reconfiguration. As an example, the confirmation received from the new serving DU may be contextModificationResponse( ) In an embodiment, the UE may apply one or more configuration changes provided by the CU 103 prior to the change in the serving cell, as part of the reconfiguration. Upon performing the configuration changes, the CU 103 may receive a confirmation from the UE. As an example, the confirmation may be a RRC Reconfiguration Acknowledgement( ) As an example, during inter-DU serving cell change, the UE may turn ON RLC re-establishment, turn ON PDCP recovery and turn ON partial MAC reset. Whereas, when there is intra-DU serving cell change, the UE may turn OFF RLC re-establishment, turn OFF PDCP recovery and turn OFF partial MAC reset. Partial MAC reset could be as inclusive as continuing to use the already procured Timing Advances (TA) and the running Time Alignment Timer (TAT).

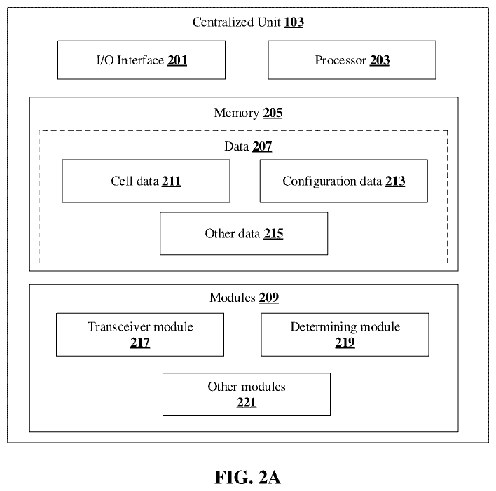

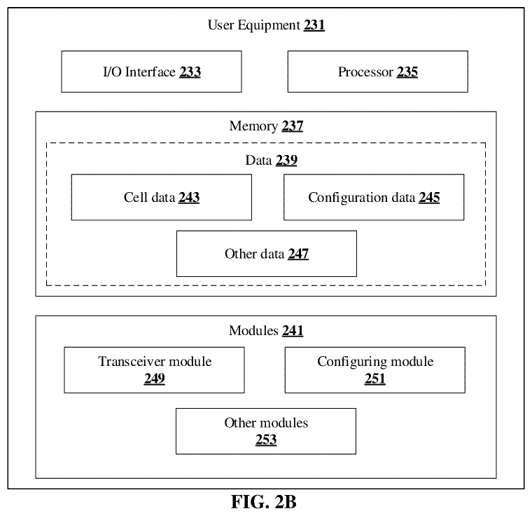

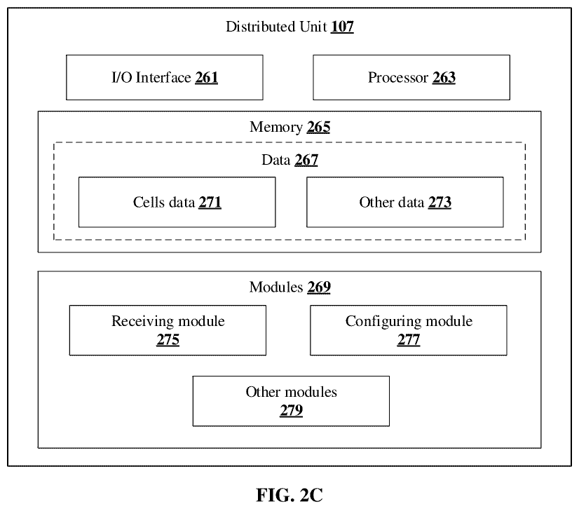

FIG. 2A shows a detailed block diagram of a Centralized Unit (CU 103), in accordance with some embodiments of the present disclosure.

In some implementations, the CU 103 may include an I/O interface 201, a processor 203 and a memory 205. In an embodiment, the memory 205 of the CU 103 may be communicatively coupled to the processor 203 of the CU 103. The processor 203 of the CU 103 may be configured to perform one or more functions of the CU 103 for handling of candidate cell reconfiguration of serving/candidate Distributed Unit (DU) and User Equipment (UE) due to intra-DS to inter-DS status change, using the data 207 and the one or more modules 209 of the CU 103. In an embodiment, the memory 205 of the CU 103 may store data 207 of the CU 103. Although the FIG. 2A shows the hardware components of the CU 103, it is to be understood that other embodiments are not limited thereon. In other embodiments, the CU 103 may include less or a greater number of components. Further, the labels or names of the components are used only for illustrative purpose and does not limit the scope. One or more components can be combined together to perform same or substantially similar technical feature for the candidate cell reconfiguration of the DU and the UE due to the intra-DU to inter-DU status change.

In an embodiment, the data 207 of the CU 103 stored in the memory 205 of the CU 103 may include, without limitation, cell data 211 of the CU 103, configuration data 213 of the CU 103 and other data 215 of the CU 103. In some implementations, the data 207 of the CU 103 may be stored within the memory 205 of the CU 103 in the form of various data structures. Additionally, the data 207 of the CU 103 may be organized using data models, such as relational or hierarchical data models. The other data 215 of the CU 103 may include various temporary data and files generated by the one or more modules 209 of the CU 103.

In an embodiment, the cell data 211 of the CU 103 may be data related to one or more cells hosted by each DU. In an embodiment, the cell may refer to a defined coverage area provided to the UE connected to the cell. The cell data 211 of the CU 103 may also include, data related to a serving cell and a new serving cell. When the serving cell is changed to the new serving cell, the cell data 211 may be updated. In an embodiment, the cell data 211 of the CU 103 may also store state of each of the one or more cells hosted by each DU. As an example, the state of the each of the one or more cells may be one of intra-DU or inter DU. For instance, if the DU hosts the serving cell, then the status of the one or more cells in the same DU may be intra-DU. Alternatively, the status of the one or more cells of the other DU's (which do not have serving cell) may be inter-DU. In an embodiment, when the serving cell for the UE is changed to a new serving cell, the CU 103 may transmit the message comprising the status change information of all the cells including their corresponding cell identifiers to a new serving DU, which may be transmitted to the UE.

In an embodiment, the configuration data 213 of the CU 103 may be one or more configuration changes provided by the CU 103 prior to the change in the serving cell, as part of the reconfiguration. As an example, the one or more configuration changes may be, without limitation, changes related to MAC reset, RLC re-establishment and PDCP recovery. In an embodiment, the one or more configuration changes may be applied by the UE when the serving cell is changed to new serving cell. The one or more configuration changes may be transmitted to the UE from the CU 103 through the new serving DU.

In an embodiment, the data 207 of the CU 103 may be processed by one or more modules 209 of the CU 103 of the CU 103. In some implementations, the one or more modules 209 may be communicatively coupled to the processor 203 of the CU 103 for performing one or more functions of the CU 103. In an implementation, the one or more modules 209 of the CU 103 may include, without limiting to, a transceiver module 217 of the CU 103, a determining module 219 of the CU 103, and other modules 221.

As used herein, the term module may refer to an Application Specific Integrated Circuit (ASIC), an electronic circuit, a hardware processor 203 of the CU 103 (shared, dedicated, or group) and memory that execute one or more software or firmware programs, a combinational logic circuit, and/or other suitable components that provide the described functionality. In an implementation, each of the one or more modules 209 of the CU 103 may be configured as stand-alone hardware computing units. In an embodiment, the other modules 221 of the CU 103 may be used to perform various miscellaneous functionalities on the CU 103. It will be appreciated that such one or more modules 209 of the CU 103 may be represented as a single module or a combination of different modules.

In an embodiment, the transceiver module 217 of the CU 103 may be configured for receiving a notification indicating a change in serving cell due to L1/L2 triggered mobility (LTM) for a User Equipment (UE), from a serving Distributed Unit (DU) of the UE in the NG-RAN. In an embodiment, prior to receiving the notification, the transceiver module 217 of the CU 103 may detect one or more candidate/target DUs among plurality of DUs 107_{N} based on a first measurement report received from the UE. Each of the one or more candidate/target DUs may host the one or more candidate/target cells. Upon detecting the one or more candidate/target DUs, the transceiver module 217 of the CU 103 may transmit a setup request or a modification request, requesting preparation of a LTM target cell configuration, to each of the one or more candidate/target DUs detected based on the first measurement report. Thereafter, the transceiver module 217 of the CU 103 may transmit the one or more configuration changes corresponding to the status change to be performed by the UE as part of the reconfiguration to the serving DU, upon receiving LTM candidate cell configurations from each of the one or more candidate/target DUs.

In an embodiment, the determining module 219 of the CU 103 may be configured for determining a status change of one or more cells of the serving DU and one or more candidate/target cells of a candidate/target DU amongst a plurality of candidate/target DU upon changing the serving cell for the UE to a new serving cell. The new serving cell is one of the one or more candidate/target cells of a candidate/target DU. In an embodiment, the determining module 219 of the CU 103 may determine a change in state of each of the one or more cells of the serving DU and each of the one or more candidate/target cells of the candidate/target DU from intra-DU to inter-DU or inter-DU to intra-DU, based on the change in the UE's serving cell

In some embodiments, the transceiver module 217 of the CU 103 may be configured for sending a message comprising the status change information of all the candidate/target cells including their corresponding cell identifiers to the new serving DU. Content of the message may be further transmitted to the UE by the new serving DU. In some other embodiments, the transceiver module 217 of the CU 103 may broadcast the serving cell change notification message to each of one or more candidate/target DUs detected by the CU 103 based on a first measurement report received from the UE. Further, the transceiver module 217 of the CU 103 may receive reconfiguration information which may comprise acknowledgment corresponding to the status change for each of the candidate/target, from each of the one or more candidate/target DUs.

In an embodiment, the transceiver module 217 of the CU 103 may be configured for receiving a confirmation of reconfiguration corresponding to the status change at the new serving DU and the UE. The transceiver module 217 of the CU 103 may receive the confirmation once the UE applies one or more configuration changes provided by the CU 103 prior to the change in the serving cell, as part of the reconfiguration.

FIG. 2B shows a detailed block diagram of a User Equipment (UE), in accordance with some embodiments of the present disclosure.

In some implementations, the UE 231 may include an I/O interface 233, a processor 235 and a memory 237. In an embodiment, the memory 237 of the UE 231 may be communicatively coupled to the processor 235 of the UE 231. The processor 235 of the UE 231 may be configured to perform one or more functions of the UE 231 for handling of candidate cell reconfiguration of serving/candidate Distributed Unit (DS) and User Equipment (UE) 231 due to intra-DU to inter-DU status change, using the data 239 and the one or more modules 241 of the UE 231. In an embodiment, the memory 237 of the UE 231 may store data 239 of the UE 231. Although the FIG. 2B shows the hardware components of the UE 231, it is to be understood that other embodiments are not limited thereon. In other embodiments, the UE 231 may include less or a greater number of components. Further, the labels or names of the components are used only for illustrative purpose and does not limit the scope. One or more components can be combined together to perform same or substantially similar technical feature for the candidate cell reconfiguration of the DU and the UE 231 due to the intra-DU to inter-DU status change.

In an embodiment, the data 239 of the UE 231 stored in the memory 237 of the UE 231 may include, without limitation, cell data 243, configuration data 245 and other data 247. In some implementations, the data 239 of the UE 231 may be stored within the memory 237 in the form of various data structures. Additionally, the data 239 of the UE 231 may be organized using data models, such as relational or hierarchical data models. The other data 247 of the UE 231 may include various temporary data and files generated by the one or more modules 241 of the UE 231.

In an embodiment, the cell data 243 of the UE 231 may be data related to serving cell of the UE 231. In an embodiment, the cell may refer to a defined coverage area provided to the UE 231 connected to the cell. The cell data 243 of the UE 231 may be updated when the serving cell may be changed to new serving cell. The data related to the new serving cell may be stored in the UE 231. In an embodiment, the cell data 211 of the UE 231 may also store state of each of the one or more candidate/target cells. As an example, the state of the each of the one or more cells may be one of intra-DU or inter DU. For instance, if the DU hosts the serving cell, then the status of the one or more cells in the same DU may be intra-DU. Alternatively, the status of the one or more cells of the other DU's (which do not have serving cell) may be inter-DU. In an embodiment, when the serving cell for the UE is changed to a new serving cell, the UE 231 may receive the message comprising the status change information of all the cells including their corresponding cell identifiers from the CU 103 through the new serving DU.

In an embodiment, the configuration data 245 of the UE 231 may be one or more configuration changes provided by the CU 103 prior to the change in the serving cell, as part of the Radio Resource Control (RRC) reconfiguration to the UE 231. As an example, the one or more configuration changes may be, without limitation, changes related to MAC reset, RLC re-establishment and PDCP recovery. In an embodiment, the UE 231 may apply one or more configuration changes, when the serving cell of the UE 231 is changed to new serving cell. The UE 231 receives the one or more configuration changes from the CU 103 through the new serving DU.

In an embodiment, the data 239 of the UE 231 may be processed by one or more modules 241 of the UE 231. In some implementations, the one or more modules 241 of the UE 231 may be communicatively coupled to the processor 235 of the UE 231 for performing one or more functions of the UE 231. In an implementation, the one or more modules 241 of the UE 231 may include, without limiting to, a transceiver module 249, a configuring module 251 and other modules 253.

As used herein, the term module may refer to an Application Specific Integrated Circuit (ASIC), an electronic circuit, a hardware processor 235 of the UE 231 (shared, dedicated, or group) and memory that execute one or more software or firmware programs, a combinational logic circuit, and/or other suitable components that provide the described functionality. In an implementation, each of the one or more modules 241 of the UE 231 may be configured as stand-alone hardware computing units. In an embodiment, the other modules 253 of the UE 231 may be used to perform various miscellaneous functionalities on the UE 231. It will be appreciated that such one or more modules 241 of the UE 231 may be represented as a single module or a combination of different modules.

In an embodiment, the transceiver module 249 of the UE 231 may be configured to receive a notification indicating change in a serving cell, from a serving Distributed Unit (DU) of a Next Generation Radio Access Network (NG-RAN). In an embodiment, prior to receiving the notification, the UE 231 may transmit a second measurement report to the serving DU periodically or based on occurrence of one or more events. As an example, the one or more events may be without limitation, when the UE connects with the network for first time, during handover of the UE and when the serving DU requests the measurement report from the UE The serving DU determines the new serving cell for the UE 231 based on the second measurement report. As an example, the second measurement report may be an intra-frequency L1 measurement report or an inter-frequency L1 measurement report.

In an embodiment, the transceiver module 249 of the UE 231 may be configured to establish a connection with a new serving cell of a new serving DU. In some embodiment, the transceiver module 249 may transmit a connection establishment request to the new serving cell to establish the connection. The UE 231 may confirm the application of new serving cell configuration to CU 103 of the NG-RAN upon establishing a successful connection with the new serving cell.

In an embodiment, when the serving cell for the UE 231 is changed to the new serving cell of the new serving DU, the transceiver module 249 of the UE 231 may be configured to receive a message comprising status change of one or more candidate/target cells of the new serving DU and all the candidate DUs/target DU from the CU 103 through the new serving DU.

In an embodiment, the configuring module 251 of the UE 231 may be configured for performing one or more configuration changes corresponding to the status change as part of reconfiguration, and sending a confirmation of the reconfiguration to the CU 103. The configuring module 251 of the UE 231 receives one or more configuration changes from the CU 103 prior to the change in the serving cell.

FIG. 2C shows a detailed block diagram of a Distributed Unit (DU), in accordance with some embodiments of the present disclosure.

In some implementations, the Distributed Unit (DU) 107_{N} may include an I/O interface 261, a processor 263 and a memory 265. In an embodiment, the memory 265 of the DU 107_{N} may be communicatively coupled to the processor 263 of the DU 107_{N}. The processor 263 of the DU 107_{N} may be configured to perform one or more functions of the DU 107_{N} for handling of candidate cell reconfiguration of serving/candidate DU and User Equipment (UE) 231 due to intra-DU to inter-DU status change, using the data 267 and the one or more modules 269 of the DU 107_{N}. In an embodiment, the memory 265 of the DU 107_{N} may store data 267 of the DU 107_{N}. Although the FIG. 2C shows the hardware components of the DU 107_{N}, it is to be understood that other embodiments are not limited thereon. In other embodiments, the DU 107_{N} may include less or a greater number of components. Further, the labels or names of the components are used only for illustrative purpose and does not limit the scope. One or more components can be combined together to perform same or substantially similar technical feature for the candidate cell reconfiguration of the DU and the DU due to the intra-DU to inter-DU status change. In an embodiment, the DU may be at least one of serving DU, candidate/target DU, and new serving DU.

In an embodiment, the data 267 of the DU 107_{N} stored in the memory 265 of the DU 107_{N} may include, without limitation, cell data 271 of the DU 107_{N} and other data 273. In some implementations, the data 267 of the DU 107_{N} may be stored within the memory 265 of the DU 107_{N} in the form of various data structures. Additionally, the data 267 of the DU 107_{N} may be organized using data models, such as relational or hierarchical data models. The other data may include various temporary data and files generated by the one or more modules 269 of the DU 107_{N}.

In an embodiment, the cell data 271 of the DU 107_{N} may be data related to one or more cells hosted by each DU. In an embodiment, the cell may refer to a defined coverage area provided to the UE 231 connected to the cell. The cell data 271 of the DU 107_{N} may also include, data related to a serving cell and a new serving cell. When the serving cell is changed to the new serving cell, the cell data 271 of the DU 107_{N} may be updated. In an embodiment, the cell data 211 of the DU 107_{N} may also store state of each of the one or more cells hosted by the DU 107_{N}. As an example, the state of the each of the one or more cells may be one of intra-DU or inter DU. For instance, if the DU hosts the serving cell, then the status of the one or more cells in the same DU may be intra-DU. Alternatively, the status of the one or more cells of the other DU's (which do not have serving cell) may be inter-DU. In an embodiment, when the serving cell for the UE is changed to a new serving cell, the serving DU and new serving DU may update the status of the one or more cells. Specifically, the status of the one or more cells of the serving DU may be changed to inter-DU from intra-DU. Similarly, the status of the one or more cells of the new serving DU may be changed to intra-DU from inter-DU.

In an embodiment, the data 267 may be processed by one or more modules 269 of the DU 107_{N}. In some implementations, the one or more modules 269 may be communicatively coupled to the processor 263 for performing one or more functions of the DU 107_{N}. In an implementation, the one or more modules 209 of the DU 107_{N} may include, without limiting to, a receiving module 275, a configuring module 277 of the DU 107_{N} and other modules 279 of the DU 107_{N}.

As used herein, the term module may refer to an Application Specific Integrated Circuit (ASIC), an electronic circuit, a hardware processor 263 of the DU 107_{N} (shared, dedicated, or group) and memory that execute one or more software or firmware programs, a combinational logic circuit, and/or other suitable components that provide the described functionality. In an implementation, each of the one or more modules 269 of the DU 107_{N} may be configured as stand-alone hardware computing units. In an embodiment, the other modules 279 of the DU 107_{N} may be used to perform various miscellaneous functionalities on the DU. It will be appreciated that such one or more modules 269 of the DU 107_{N} may be represented as a single module or a combination of different modules.

In an embodiment, the receiving module 275 may be configured for receiving a connection establishment from a User Equipment (UE) 231 after changing a serving cell to a new serving cell belonging to a new serving DU. In an embodiment, the receiving module 275 may be receiving receive a message comprising status change of a one or more of cells of the candidate/target DU and the new serving DU, from the CU 103, when the serving cell for the UE 231 is changed to the new serving cell, and transmitting the content of the message from the CU to the UE 231 using a Layer 1 message or a Layer 2 message. As an example, the Layer 1 message or the Layer 2 message may be used to communicate between the UE 231 and the serving DU.

In an embodiment, the configuring module 277 may be configured for reconfiguring the new serving DU based on the status change and sending a confirmation of the reconfiguration to the CU 103.

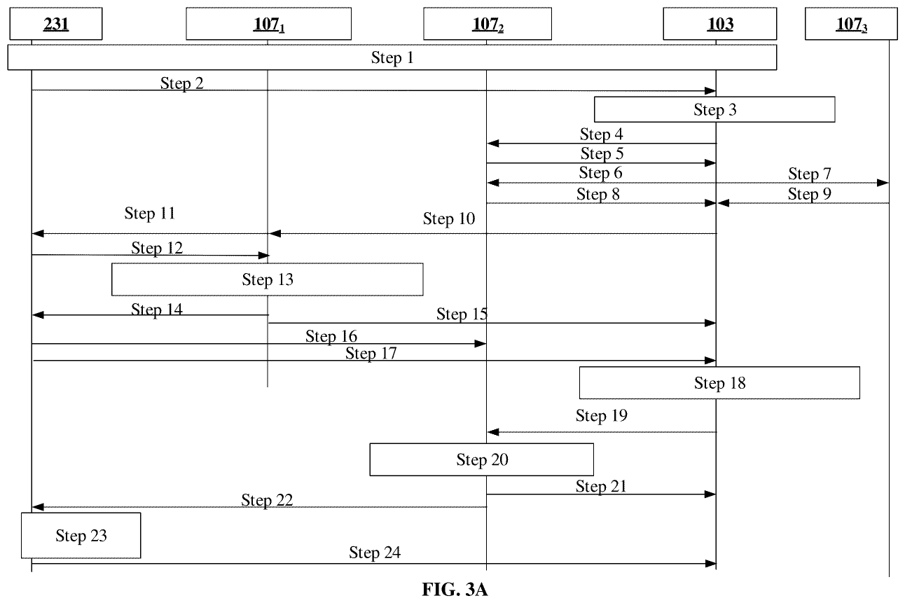

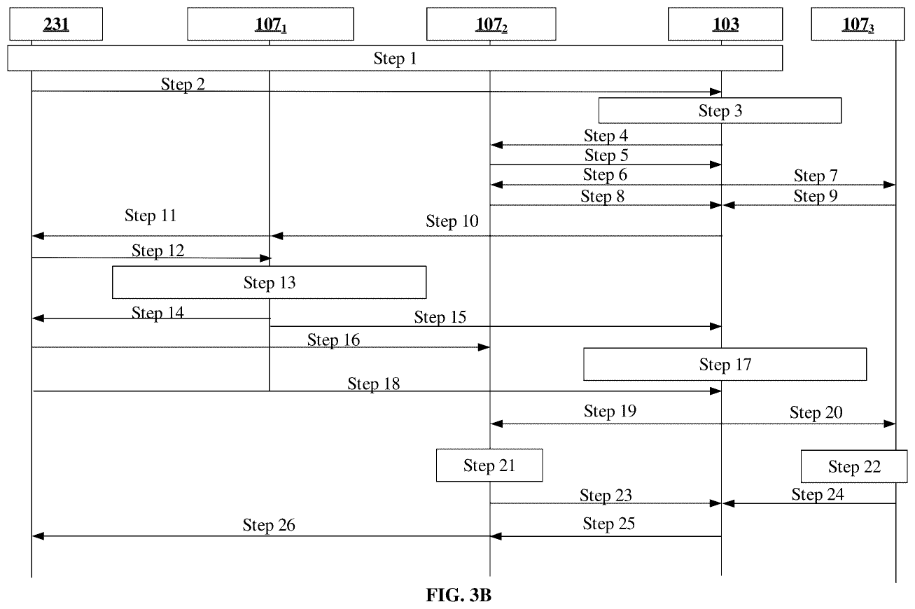

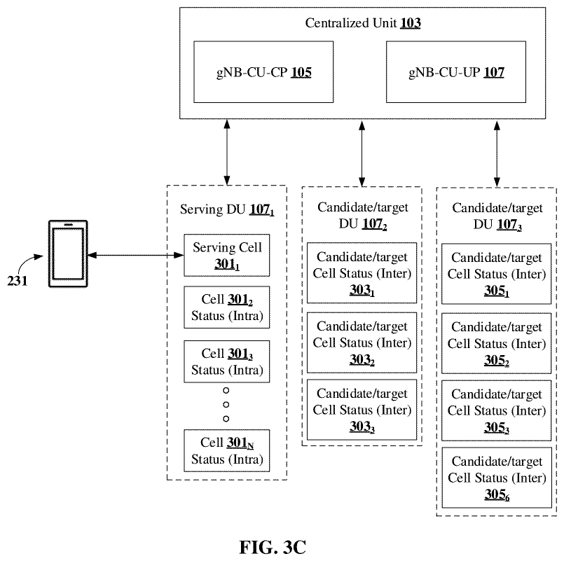

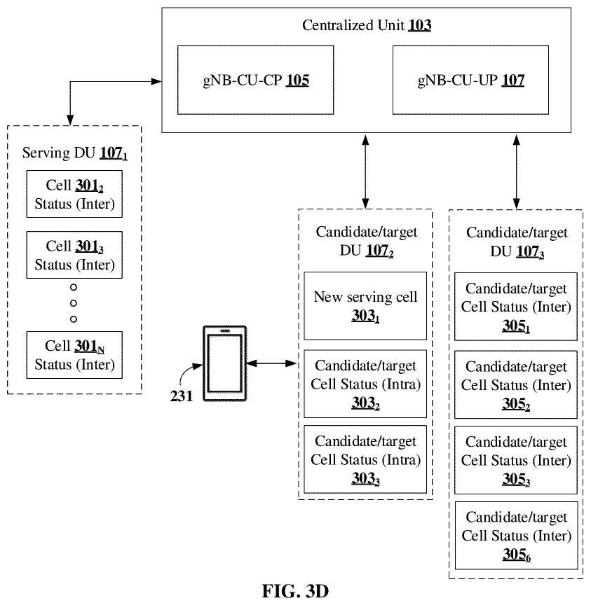

FIG. 3A shows an exemplary call flow diagram illustrating handling of candidate cell reconfiguration of serving/candidate Distributed Unit (DU) and User Equipment (UE) 231 due to intra-DU to inter-DU status change, in accordance with some embodiments of the present disclosure.

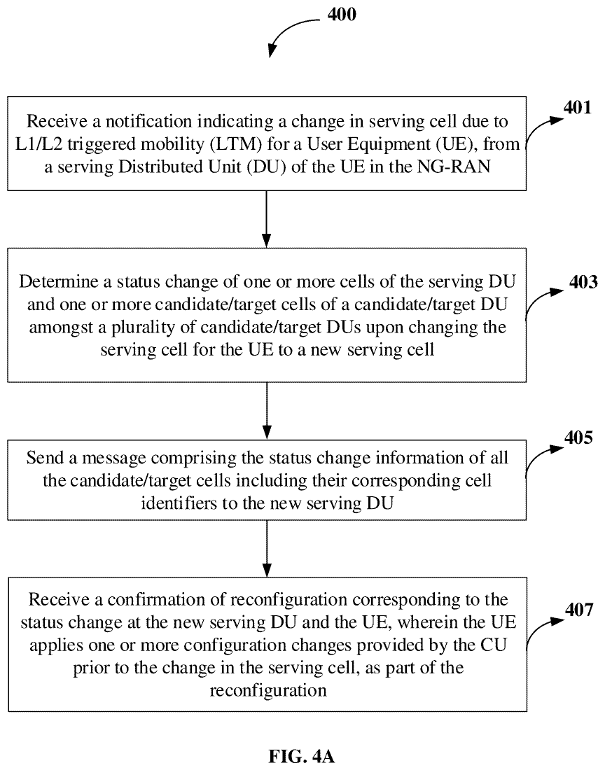

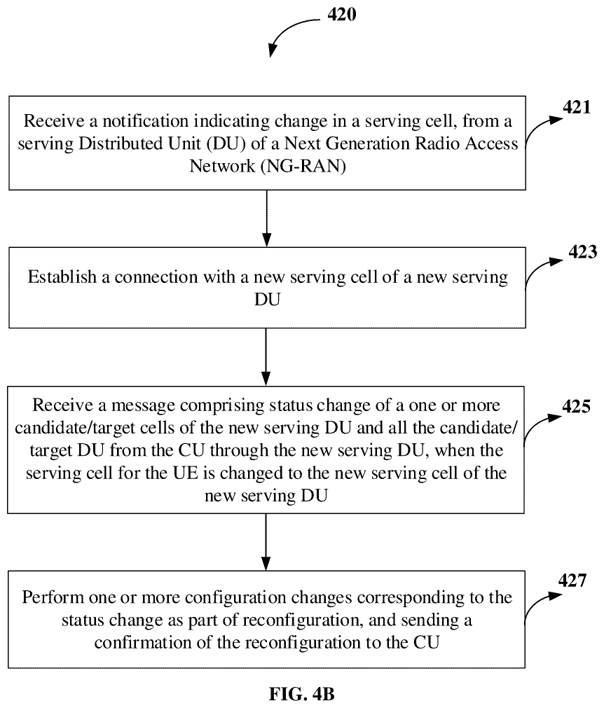

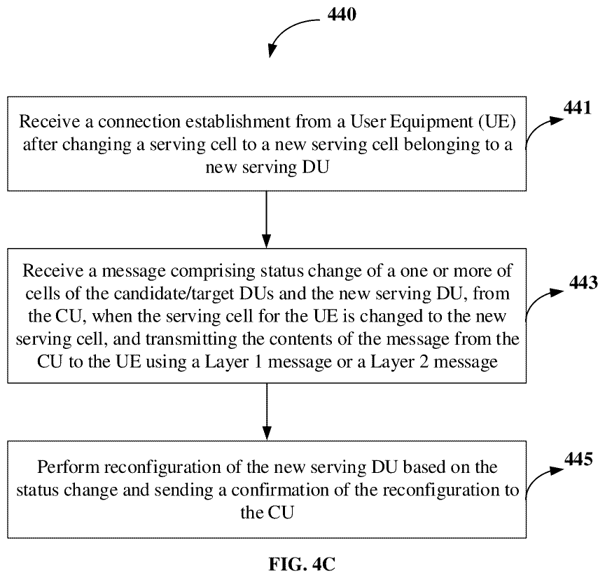

Referring to the FIG. 3A, at step 1, a User Equipment (UE) 231 may be served by a serving Distributed Unit (DU) 107₁. The UE 231 may be configured with L1/L2 triggered mobility (LTM). The LTM allows network to trigger handover of the UE 231. At step 2, the UE 231 may send RRC Measurements (L3) to CU 103. At step 3, the CU 103 may take the decision to prepare inter-gNB DU LTM candidate cell based on the RRC Measurements (L3) received from the UE 231. Referring to FIG. 4C, as shown in the figure, the CU 103 may include three DUs. The UE 231 may be currently configured with serving DU 107₁ which hosts cells 301₁-301_{N} and specifically, the UE 231 may be served by a cell 301₁. Based on the RRC Measurements (L3), the CU 103 may detect candidate/target DU 107₂ and 107₃ which may host cells 303₁-303_{N} and 305₁-305_{N} respectively (not shown in figure). However, the candidate/target cells in detected in the candidate/target DU 107₂ and 107₃ may be 303₁-303₃ and 305₁-305₃, 303₆ respectively. The status of the one or more cells 301₁-301_{N} of the serving DU may be intra as the serving cell is hosted in the same DU. Alternatively, the status of the one or more cells 303₁-303_{N} of the candidate/target DU 107₂ may be inter as the serving cell is hosted in different DU. Similarly, the status of the one or more cells 305₁-305_{N} of the candidate/target DU 107₃ may be inter as the serving cell is hosted in different DU.

At step 4, the CU 103 may be configured to transmit a F1: UE 231 context Modification Request ( ) to the serving DU 107₁ and at step 5 the serving DU may respond to the modification request by sending the F1: UE 231 context Modification Response ( ) to the CU 103. At step 6, the CU 103 may be configured to transmit a F1: UE context setup request message to the candidate/target DU 107₂ and similarly at step 7, the CU 103 may be configured to transmit the F1: UE context setup request message to the candidate/target DU 107₃. The setup request is transmitted to prepare the new candidate/target cells in their respective DU. At step 8, the CU 103 receives a F1: UE 231 Context Setup Response (CellGroupConfig) from the candidate/target DU 107₂ and at step 9, the CU 103 receives the F1: UE Context Setup Response (CellGroupConfig) from the candidate/target DU 107₃. At this point, the target DU has provided the candidate LTM cell configurations to candidate/target DU 107₂ and 107₃. Referring back to FIG. 3C, the CU 103 may transmit the F1: UE context setup request message to the candidate/target DU 107₂ and 107₃. Further, the CU 103 receives the F1: UE Context Setup Response (CellGroupConfig) from the candidate/target DU 107₂ and 107₃.

At step 10, the CU 103 may be configured to transmit F1: DL RRC Message transfer (RRC Reconfiguration (LTM target cell configuration, Reconfiguration for intra-DU↔inter-DU changes)) to the serving DU 107₁. At step 11, the serving DU 107₁ may be configured to transmit RRC Reconfiguration (LTM target cell configuration, Reconfiguration for intra-DU ↔inter-DU changes)) to the UE 231. Here, the list of reconfiguration actions which may be applicable on an LTM candidate cell undergoing status change from intra DU to inter DU and vice versa are present in the list of reconfiguration actions. The list of reconfiguration actions may be expected to be applied by the UE 231 wherever such status change information is delivered to the UE 231. At step 12, the UE 231 may be configured to transmit intra-frequency L1 Measurement report to the serving DU 107₁. At step 13, the serving DU 107₁ may be configured to determine if the LTM HO radio condition is satisfied by any candidate/target cell. If yes, the CU 103 may perform serving cell change to one of the prepared one or more candidate/target cells. At step 14, the serving DU 107₁ may be configured to send MAC CE (Serving Cell Change command) to the UE 231 and at step 15, the serving DU 107₁ may be 103. The Cell ID of the new serving cell may be sent to the UE 231. Referring to FIG. 3D, the CU 103 may perform serving cell change to new serving cell 303₁ hosted in new serving DU 107₂. As the new serving cell 303₁ is hosted in new serving DU 107₂, the status of the cells hosted by the serving DU 107₁ (which was previous serving DU, as the UE 231 is connected with new serving DU 107₂) is changed to inter-DU from intra-DU. Similarly, the status of cells hosted by the new serving DU 107₂ may be changed to intra-DU from inter-DU as the new serving cell 303₁ is hosted in new serving DU 107₂. However, the status of the cells hosted by the candidate/target DU 107₃ remains same and there is no requirement to update the status of the cells hosted by the candidate/target DU 107₃ as the new serving cell 303₁ is hosted in new serving DU 107₂.

Further, at step 16, the UE 231 may be configured to transmit RACH (Preamble) to the new serving cell 303₁. The new serving cell 303₁ may be a cell among one or more candidate/target cells. At step 17, the UE 231 may be configured to transmit the RRC Reconfiguration Acknowledgement ( ) to the CU 103. At step 18, based on the new serving cell 303₁ of the new serving DU 107₂ information received from the old serving DU, the CU 103 may be configured to determine the intra-DU↔inter DU status changes in all the candidate cell configuration and send the updated list to the new serving DU 107₂. At step 19, the CU 103 may send F1: UE 231 context Modification Request (updated intra-DU↔inter DU change list) to the new serving DU 107₂. At step 20, the new serving DU 107₂ may initiate re-configuration for intra-DU↔inter DU related changes towards the UE 231. Meanwhile, at step 21, the new serving DU 107₂ sends the F1: UE 231 context Modification Response ( ) to the CU 103. Further, at step 22, the new serving DU may be configured to transmit a DL MAC CE (intra-DU↔inter DU change list) to the UE 231 to indicate all the intra-DU↔inter-DU status changes. At step 23, the UE 231 may be configured to initiate re-configuration for intra-DU↔inter DU related changes (configured by CU 103 earlier in the RRC message, step 10). At step 24, the UE 231 may be configured to send confirmation to the CU 103, the UE 231 may be configured to transmit an RRC Reconfiguration Acknowledgement( ) to the CU 103. In an embodiment, the CU 103 may include the list of reconfigurations to be performed whenever an intra-DU candidate cell is reconfigured as an inter-DU candidate cell and vice-versa. This is sent to the UE 231 in the RRC re-configuration message whenever an inter-DU candidate cell is configured. As an example, when intra-DU changes to inter-DU: Turn ON RLC re-establishment and PDCP recovery and turn OFF Partial MAC reset. When inter-DU changes to intra-DU: Turn ON Partial MAC reset AND Turn OFF RLC re-establishment and PDCP recovery.

In an embodiment, upon executing the LTM serving cell change (via a MAC CE in downlink to the UE) 231, the serving DU sends a serving cell change notification to the CU 103 (step 15). This is required to ensure that the CU 103 is aware of the UE's 231 new serving cell (used for paging and other procedures). Upon receiving an LTM serving cell change notification from the serving DU 107₁, the CU 103 may be configured to send the list of intra-DU↔inter-DU re-configurations to the new serving DU. It is to be noted that the re-configuration information is required for both directions. The new serving DU delivers the intra-DU↔inter-DU re-configuration information to the UE 231 in DL MAC CE signaling. The UE 231 applies the list of re-configurations whenever an intra-DU candidate cell is re-configured as an inter-DU candidate cell and vice-versa, based on the configuration sent by CU 103 (over RRC). This step is performed to cover the known re-configurations due to LTM candidate cells becoming intra-DU↔inter-DU due to a serving cell change and do not include the regular RRC Re-configurations that a target DU may have to initiate because of resource situation changes or other configuration aspects.

FIG. 3B shows an exemplary call flow diagram illustrating broadcasting of status change to one or more candidate Distributed Units (DUs), in accordance with some embodiments of the present disclosure.

Referring to the FIG. 3A, at step 1, a User Equipment (UE) 231 may be served by a serving Distributed Unit (DU) 107₁. The UE 231 may be configured with L1/L2 triggered mobility (LTM). The LTM allows network to trigger handover of the UE 231. At step 2, the UE 231 may send RRC Measurements (L3) to CU 103. At step 3, the CU 103 may take the decision to prepare inter-gNB DU LTM candidate cell based on the RRC Measurements (L3) received from the UE 231. Referring to FIG. 4C, as shown in the figure, the CU 103 may include three DUs. The UE 231 may be currently configured with serving DU 107₁ which hosts cells 301₁-301_{N} and specifically, the UE 231 may be served by a cell 301₁. Based on the RRC Measurements (L3), the CU 103 may detect candidate/target DU 107₂ and 107₃ which may host cells 303₁-303_{N} and 305₁-305_{N} respectively (not shown in figure). However, the candidate/target cells in detected in the candidate/target DU 107₂ and 107₃ may be 303₁-303₃ and 305₁-305₃, 303₆ respectively. The status of the one or more cells 301₁-301_{N} of the serving DU may be intra as the serving cell is hosted in the same DU. Alternatively, the status of the one or more cells 303₁-303_{N} of the candidate/target DU 107₂ may be inter as the serving cell is hosted in different DU. Similarly, the status of the one or more cells 305₁-305_{N} of the candidate/target DU 107₃ may be inter as the serving cell is hosted in different DU.

At step 4, the CU 103 may be configured to transmit a F1: UE 231 context Modification Request( ) to the serving DU 107₁ and at step 5 the serving DU may respond to the modification request by sending the F1: UE 231 context Modification Response( ) to the CU 103. At step 6, the CU 103 may be configured to transmit a F1: UE context setup request message to the candidate/target DU 107₂ and similarly at step 7, the CU 103 may be configured to transmit the F1: UE context setup request message to the candidate/target DU 107₃. The setup request is transmitted to prepare the new candidate/target cells in their respective DU. At step 8, the CU 103 receives a F1: UE 231 Context Setup Response (CellGroupConfig) from the candidate/target DU 107₂ and at step 9, the CU 103 receives the F1: UE Context Setup Response (CellGroupConfig) from the candidate/target DU 107₃. At this point, the target DU has provided the candidate LTM cell configurations to candidate/target DU 107₂ and 107₃. Referring back to FIG. 3C, the CU 103 may transmit the F1: UE context setup request message to the candidate/target DU 107₂ and 107₃. Further, the CU 103 receives the F1: UE Context Setup Response (CellGroupConfig) from the candidate/target DU 107₂ and 107₃.

At step 10, the CU 103 may be configured to transmit F1: DL RRC Message transfer (RRC Reconfiguration (LTM target cell configuration, Reconfiguration for intra-DU↔inter-DU changes)) to the serving DU 107₁. At step 11, the serving DU 107₁ may be configured to transmit RRC Reconfiguration (LTM target cell configuration, Reconfiguration for intra-DU ↔inter-DU changes)) to the UE 231. Here, the list of reconfiguration actions which may be applicable on an LTM candidate cell undergoing status change from intra DU to inter DU and vice versa are present in the list of reconfiguration actions. The list of reconfiguration actions may be expected to be applied by the UE 231 wherever such status change information is delivered to the UE 231. At step 12, the UE 231 may be configured to transmit intra-frequency L1 Measurement report to the serving DU 107₁. At step 13, the serving DU 107₁ may be configured to determine if the LTM HO radio condition is satisfied by any candidate/target cell. If yes, the CU 103 may perform serving cell change to one of the prepared one or more candidate/target cells. At step 14, the serving DU 107₁ may be configured to send MAC CE (Serving Cell Change command) to the UE 231 and at step 15, the serving DU 107₁ may be 103. The Cell ID of the new serving cell may be sent to the UE 231. Referring to FIG. 3D, the CU 103 may perform serving cell change to new serving cell 303₁ hosted in new serving DU 107₂. As the new serving cell 303₁ is hosted in new serving DU 107₂, the status of the cells hosted by the serving DU 107₁ (which was previous serving DU, as the UE 231 is connected with new serving DU 107₂) is changed to inter-DU from intra-DU. Similarly, the status of cells hosted by the new serving DU 107₂ may be changed to intra-DU from inter-DU as the new serving cell 303₁ is hosted in new serving DU 107₂. However, the status of the cells hosted by the candidate/target DU 107₃ remains same and there is no requirement to update the status of the cells hosted by the candidate/target DU 107₃ as the new serving cell 303₁ is hosted in new serving DU 107₂.

Further, at step 16, the UE 231 may be configured to transmit RACH (Preamble) to the new serving DU 107₂. The new serving cell may be a cell among one or more candidate/target cells. At step 17, the CU 103 may broadcast LTM serving cell change notification to all candidate DUs/target DU. Referring to our FIG. 3B, LTM serving cell change notification may be broadcasted to candidate/target DU 107₂ and 107₃. At step 18, the UE 231 may send an RRC Reconfiguration Acknowledgement( ) to the CU 103. At step 19, as part of broadcasting, the CU 103 sends F1: UE 231 context Modification Request (updated intra-DU↔inter DU change list) to the new serving DU 107₂ and at step 20, as part of broadcasting, the CU 103 may send the F1: UE 231 context Modification Request (updated intra-DU↔inter DU change list) to the candidate/target DU 107₃. At step 21, the new serving DU 107₂ may initiate the RRC Reconfig including intra-DU↔inter DU related changes if there are any other LTM candidate cells belonging to this DU and at step 22, the candidate DU 107₃ may initiate the RRC Reconfig including intra-DU↔inter DU related changes. At step 23, the new serving DU 107₂ may transmit the F1: UE 231 context Modification Response (Updated CellGroupConfig) to the CU 103 and at step 24 the candidate DU 107₃ may transmit the F1: UE 231 context Modification Response (Updated CellGroupConfig) to the CU 103. This includes the updated candidate cell configuration. Further, at step 25, the CU 103 sends F1: DL RRC Message transfer (RRC Reconfiguration (modified LTM target cell configurations)) to the new serving DU 107₂. Here, the RRC message is a container insider F1 message. At step 26, the new serving DU 107₂ may transmit the RRC Reconfiguration (modified LTM target cell configurations( )) to the UE 231

Therefore, in the proposed embodiment, after executing the LTM SCC (via a MAC CE in downlink to the UE) 231, the serving DU sends a serving cell change notification to the CU 103 (step 15). This step is performed to ensure that the CU 103 is aware of the UE's 231 Current serving cell which may be used for paging etc. The CU 103 may broadcast the notification message to all the candidate/target DU including the new serving DU and the serving DU. Based on this, each target DU issues a re-configuration (if required only) and delivers it to the UE 231 via the CU 103.

FIG. 4A shows a flowchart illustrating a method for handling of candidate cell reconfiguration of serving/candidate Distributed Unit (DU) and User Equipment (UE) 231 due to intra-DU to inter-DU status change, in accordance with some embodiments of the present disclosure.

As illustrated in FIG. 4A, the method 400 may include one or more blocks illustrating a method for handling of candidate cell reconfiguration of serving/candidate Distributed Unit (DU) and User Equipment (UE) 231 due to intra-DU to inter-DU status change, in accordance with some embodiments of the present disclosure illustrated in FIG. 2A. The method 400 may be described in the general context of computer executable instructions. Generally, computer executable instructions can include routines, programs, objects, components, data structures, procedures, modules, and functions, which perform specific functions or implement specific abstract data types.

The order in which the method 400 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 401, the method 400 includes receiving, by a processor 203 of the Centralized Unit (CU 103), a notification indicating a change in serving cell due to L1/L2 triggered mobility (LTM) for a UE 231, from a serving DU of the UE in a Next Generation Radio Access Network (NG-RAN). The notification received from the serving DU comprises an Identification Number of the new serving cell of the new serving DU among one or more candidate/target DUs determined for serving the UE 231. In an embodiment, prior to receiving the notification, the processor 203 detects one or more candidate/target DUs among plurality of DUs 107_{N} based on a first measurement report received from the UE 231. Each of the one or more candidate/target DUs comprise the one or more candidate/target cells. Further, the processor 203 transmits a setup request or a modification request, requesting preparation of a LTM target cell configuration, to each of the one or more candidate/target DUs detected based on the first measurement report. Thereafter, the processor 203 transmits the one or more configuration changes corresponding to the status change to be performed by the UE 231 as part of the reconfiguration to the serving DU, upon receiving LTM candidate cell configurations from each of the one or more candidate/target DUs.

At block 403, the method 400 includes determining, by the processor 203, a status change of one or more cells of the serving DU and one or more candidate/target cells of a candidate/target DU amongst a plurality of candidate/target DU upon changing the serving cell for the UE 231 to a new serving cell. The new serving cell is one of the one or more candidate/target cells of a candidate/target DU. In an embodiment, to determine the status change, the processor 203 is determines a change in state of each of the one or more cells of the serving DU and each of the one or more candidate/target cells of the candidate/target DU from intra-DU to inter-DU or inter-DU to intra-DU, based on the change in the UE's 231 serving cell.

At block 405, the method 400 includes sending, by the processor 203, a message comprising the status change information of all the candidate/target cells including their corresponding cell identifiers to the new serving DU. Content of the message is further transmitted to the UE 231 by the new serving DU. In some embodiments, the content of the message may include the status change information of all the candidate/target cells including their corresponding cell identifiers. In an embodiment, the processor 203 may broadcast the serving cell change notification message to each of one or more candidate/target DUs detected by the CU 103 based on a first measurement report received from the UE 231. Further, the processor 203 may receive a reconfiguration information corresponding to the status change for each of the candidate/target cells, from each of the one or more candidate/target DUs.

At block 407, the method 400 includes receiving, by the processor 203, a confirmation of reconfiguration corresponding to the status change at the new serving DU and the UE 231. The UE 231 applies one or more configuration changes provided by the CU 103 prior to the change in the serving cell, as part of the reconfiguration. The one or more configuration changes are provided to the UE 231 using a Radio Resource Control (RRC) configuration message.

FIG. 4B shows a flowchart illustrating a method for handling of candidate cell reconfiguration of serving/candidate Distributed Unit (DU) and User Equipment (UE) 231 due to intra-DU to inter-DU status change, in accordance with some embodiments of the present disclosure.

As illustrated in FIG. 4B, the method 420 may include one or more blocks illustrating a method for handling of candidate cell reconfiguration of serving/candidate Distributed Unit (DU) and User Equipment (UE) 231 due to intra-DU to inter-DU status change, in accordance with some embodiments of the present disclosure illustrated in FIG. 2B. The method 420 may be described in the general context of computer executable instructions. Generally, computer executable instructions can include routines, programs, objects, components, data structures, procedures, modules, and functions, which perform specific functions or implement specific abstract data types.

The order in which the method 420 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 421, the method 420 includes receiving, by a processor 235 of the User Equipment (UE) 231, a notification indicating change in a serving cell, from a serving Distributed Unit (DU) of a Next Generation Radio Access Network (NG-RAN). In an embodiment, prior to receiving the notification, the processor 235 transmits a second measurement report to the serving DU periodically or based on occurrence of one or more events. As an example, the one or more events may be without limitation, when the UE connects with the network for first time, during handover of the UE and when the serving DU requests the measurement report from the UE. The serving DU determines the new serving cell for the UE 231 based on the second measurement report.

At block 423, the method 420 includes establishing, by the processor 235 of UE 231, a connection with a new serving cell of a new serving DU. In an embodiment, the UE 231 may transmit a connection establishment request to establish the connection. The UE 231 confirms the application of new serving cell configuration to Centralized Unit (CU 103) of the NG-RAN upon establishing a successful connection with the new serving cell.

At block 425, the method 420 includes receiving, by the processor 235 of UE 231, a message comprising status change of a one or more candidate/target cells of the new serving DU and all the candidate/target DU from the CU 103 through the new serving DU, when the serving cell for the UE 231 is changed to the new serving cell of the new serving DU.

At block 427, the method 420 includes performing, by the processor 235 of UE 231, one or more configuration changes corresponding to the status change as part of reconfiguration, and sending a confirmation of the reconfiguration to the CU 103. The one or more configuration changes are received from the CU 103 prior to the change in the serving cell.

FIG. 4C shows a flowchart illustrating a method for handling of candidate cell reconfiguration of serving/candidate Distributed Unit (DU) and User Equipment (UE) 231 due to intra-DU to inter-DU status change, in accordance with some embodiments of the present disclosure.

As illustrated in FIG. 4C, the method 440 may include one or more blocks illustrating a method for handling of candidate cell reconfiguration of serving/candidate Distributed Unit (DU) and User Equipment (UE) 231 due to intra-DU to inter-DU status change, in accordance with some embodiments of the present disclosure illustrated in FIG. 2C. The method 440 may be described in the general context of computer executable instructions. Generally, computer executable instructions can include routines, programs, objects, components, data structures, procedures, modules, and functions, which perform specific functions or implement specific abstract data types.

The order in which the method 440 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 441, the method 440 includes receiving, by a processor 263 of the DU 107_{N}, a connection establishment from a User Equipment (UE) 231 after changing a serving cell to a new serving cell belonging to a new serving DU.

At block 443, the method 440 includes receiving, by the processor 263 of the DU 107_{N}, a message comprising status change of a one or more of cells of the candidate/target DU and the new serving DU, from the CU 103, when the serving cell for the UE 231 is changed to the new serving cell, and transmitting the content of the message from the CU 103 to the UE 231 using a Layer 1 message or a Layer 2 message.

At block 445, the method 440 includes performing, by the processor 263 of the DU 107_{N}, reconfiguration of the new serving DU based on the status change and sending a confirmation of the reconfiguration to the CU 103.

### Claimable Aspects:

1. In an embodiment, a Centralized Unit (CU) of a Next Generation Radio Access Network (NG-RAN) for handling of candidate cell reconfiguration of serving/candidate Distributed Unit (DU) and User Equipment (UE) due to intra-DU to inter-DU status change is disclosed in an aspect. The CU comprises a processor and a memory. The memory is communicatively coupled to the processor and stores processor-executable instructions, which on execution, cause the processor to receive a notification indicating a change in serving cell due to L1/L2 triggered mobility (LTM) for a UE, from a serving DU of the UE in the NG-RAN. Further, the processor determines a status change of one or more cells of the serving DU and one or more candidate/target cells of a candidate/target DU amongst a plurality of candidate/target DU upon changing the serving cell for the UE to a new serving cell. The new serving cell is one of the one or more candidate/target cells of a candidate/target DU. Thereafter, the processor sends a message comprising the status change information of all the candidate/target cells including their corresponding cell identifiers to the new serving DU. Content of the message is further transmitted to the UE by the new serving DU. Finally, the processor receives a confirmation of reconfiguration corresponding to the status change at the new serving DU and the UE. The UE applies one or more configuration changes provided by the CU prior to the change in the serving cell, as part of the reconfiguration.
2. In an embodiment, the CU as described in preceding aspect 1, wherein to determine the status change, the processor is configured to determine a change in state of each of the one or more cells of the serving DU and each of the one or more candidate/target cells of the candidate/target DU from intra-DU to inter-DU or inter-DU to intra-DU, based on the change in the UE's serving cell.
3. In an embodiment, the CU as described in preceding aspect 1 to 2, wherein prior to receiving the notification, the processor is configured to detect one or more candidate/target DUs among plurality of DUs based on a first measurement report received from the UE, wherein each of the one or more candidate/target DUs comprise the one or more candidate/target cells. The processor is configured to transmit a setup request or modification request, requesting preparation of a LTM target cell configuration, to each of the one or more candidate/target DUs detected based on the first measurement report. The processor is configured to transmit the one or more configuration changes corresponding to the status change to be performed by the UE as part of the reconfiguration to the serving DU, upon receiving LTM candidate cell configurations from each of the one or more candidate/target DUs.
4. In an embodiment, the CU as described in preceding aspect 1 to 3, wherein the one or more configuration changes are provided to the UE using a Radio Resource Control (RRC) configuration message.
5. In an embodiment, the CU as described in preceding aspect 1 to 4, wherein to send the message comprising the status change, the processor is configured to broadcast the serving cell change notification message to each of one or more candidate/target DUs detected by the CU based on a first measurement report received from the UE. The processor is configured to receive a reconfiguration information corresponding to the status change for each of the candidate/target cells, from each of the one or more candidate/target DUs.
6. In an embodiment, the CU as described in preceding aspect 1 to 5, wherein the notification received from the serving DU comprises an Identification Number of the new serving cell of the new serving DU among one or more candidate/target DUs determined for serving the UE.
7. In an embodiment, a User Equipment (UE) for handling of candidate cell reconfiguration of serving/candidate Distributed Unit (DU) and UE due to intra-DU to inter-DU status change is disclosed in an aspect. The UE comprises a processor and a memory. The memory is communicatively coupled to the processor and stores processor-executable instructions, which on execution, cause the processor to receive a notification indicating change in a serving cell, from a serving Distributed Unit (DU) of a Next Generation Radio Access Network (NG-RAN). Further, the processor establishes a connection with a new serving cell of a new serving DU. The UE confirms the application of new serving cell configuration to Centralized Unit (CU) of the RAN upon establishing a successful connection with the new serving cell. Thereafter, the processor receives a message comprising status change of a one or more candidate/target cells of the new serving DU and all the candidate/target DU from the CU through the new serving DU, when the serving cell for the UE is changed to the new serving cell of the new serving DU. Finally, the processor performs one or more configuration changes corresponding to the status change as part of reconfiguration, and sends a confirmation of the reconfiguration to the CU. The one or more configuration changes are received from the CU prior to the change in the serving cell.
8. In an embodiment, the CU as described in preceding aspect 7, wherein prior to receiving the notification, the processor is configured to transmit a second measurement report to the serving DU periodically or based on occurrence of one or more events, wherein the serving DU determines the new serving cell for the UE based on the second measurement report, wherein the second measurement report is an intra-frequency L1 measurement report or an inter-frequency L1 measurement report.
9. In an embodiment, a Distributed Unit (DU) for handling of candidate cell reconfiguration of serving/candidate DU and UE due to intra-DU to inter-DU status change is disclosed in an aspect. The new serving DU comprises a processor and a memory. The memory is communicatively coupled to the processor and stores processor-executable instructions, which on execution, cause the processor to receive a connection establishment from a UE after changing a serving cell to a new serving cell belonging to a new serving DU. Further, the processor receives a message comprising status change of a one or more of cells of the candidate/target DU and the new serving DU, from the CU, when the serving cell for the UE is changed to the new serving cell, and transmitting the content of the message from the CU to the UE using a Layer 1 message or a Layer 2 message. Finally, the processor performs reconfiguration of the new serving DU based on the status change and sending a confirmation of the reconfiguration to the CU.
10. In another embodiment, a method for handling of candidate cell reconfiguration of serving/candidate Distributed Unit (DU) and User Equipment (UE) due to intra-DU to inter-DU status change is disclosed in an aspect. The method includes receiving, by a Centralized Unit (CU) of a Next Generation Radio Access Network (NG-RAN node), a notification indicating a change in serving cell due to L1/L2 triggered mobility (LTM) for a UE, from a serving DU of the UE in the NG-RAN. Further, the method comprises determining a status change of one or more cells of the serving DU and one or more candidate/target cells of a candidate/target DU amongst a plurality of candidate/target DU upon changing the serving cell for the UE to a new serving cell. The new serving cell is one of the one or more candidate/target cells of a candidate/target DU. Thereafter, the method comprises sending a message comprising the status change information of all the candidate/target cells including their corresponding cell identifiers to the new serving DU. Content of the message is further transmitted to the UE by the new serving DU. Finally, the method comprises receiving a confirmation of reconfiguration corresponding to the status change at the new serving DU and the UE. The UE applies one or more configuration changes provided by the CU prior to the change in the serving cell, as part of the reconfiguration.
11. In an embodiment, the method as described in preceding aspect 10, wherein determining the status change comprises determining, by the CU, a change in state of each of the one or more cells of the serving DU and each of the one or more candidate/target cells of the candidate/target DU from intra-DU to inter-DU or inter-DU to intra-DU, based on the change in the UE's serving cell.
12. In an embodiment, the method as described in preceding aspect 10 to 11, wherein prior to receiving the notification, the method comprises detecting, by the CU, one or more candidate/target DU among plurality of DU based on a first measurement report received from the UE, wherein each of the one or more candidate/target DU comprise the one or more candidate/target cells. The method comprises transmitting, by the CU, a setup request or modification request, requesting preparation of a LTM target cell configuration, to each of the one or more candidate/target DUs detected based on the first measurement report. The method comprises transmitting, by the CU, the one or more configuration changes corresponding to the status change to be performed by the UE as part of the reconfiguration, upon receiving LTM candidate cell configurations from each of the one or more candidate/target DUs.
13. In an embodiment, the method as described in preceding aspect 10 to 12, wherein the one or more configuration changes are provided to the UE using a Radio Resource Control (RRC) configuration message.
14. In an embodiment, the method as described in preceding aspect 10 to 13, wherein sending the message comprising the status change further comprises broadcasting, by the CU, the serving cell change notification message to each of one or more candidate/target DU detected by the CU based on a first measurement report received from the UE and receiving, by the CU, a reconfiguration information corresponding to the status change for each of the candidate/target cells, from each of the one or more candidate/target DUs.
15. In an embodiment, the method as described in preceding aspect 10 to 14, wherein the notification received from the serving DU comprises an Identification Number of the new serving cell of the new serving DU among one or more candidate/target DUs determined for serving the UE.
16. In another embodiment, a method for handling of candidate cell reconfiguration of serving/candidate Distributed Unit (DU) and User Equipment (UE) due to intra-DU to inter-DU status change is disclosed in an aspect. The method includes receiving, by a User Equipment (UE), a notification indicating change in a serving cell, from a serving Distributed Unit (DU) of a Next Generation Radio Access Network (NG-RAN). Further, the method comprises establishing a connection with a new serving cell of a new serving DU. The UE confirms the application of new serving cell configuration to Centralized Unit (CU) of the RAN upon establishing a successful connection with the new serving cell. Thereafter, the method comprises receiving a message comprising status change of one or more candidate/target cells of the new serving DU and all the candidate/target DU from the CU through the new serving DU, when the serving cell for the UE is changed to the new serving cell of the new serving DU. Finally, the method comprises performing one or more configuration changes corresponding to the status change as part of reconfiguration, and sending a confirmation of the reconfiguration to the CU. The one or more configuration changes are received from the CU prior to the change in the serving cell.
17. In an embodiment, the method as described in preceding aspect 16, wherein prior to receiving the notification, the method comprises transmitting, by the UE, a second measurement report to the serving DU periodically or based on occurrence of one or more events, wherein the serving DU determines the new serving cell for the UE based on the second measurement report.
18. In another embodiment, a method for handling of candidate cell reconfiguration of serving/candidate Distributed Unit (DU) and User Equipment (UE) due to intra-DU to inter-DU status change is disclosed in an aspect. The method includes receiving, by a new serving DU, a connection establishment from a UE after changing a serving cell to a new serving cell belonging to a new serving DU. Further, the method comprises receiving a message comprising status change of a one or more of candidate/target cells of the candidate/target DU and the new serving DU, from the CU, when the serving cell for the UE is changed to the new serving cell, and transmitting the content of the message from the CU to the UE using a Layer 1 message or a Layer 2 message. Finally, the method comprises performing reconfiguration of the new serving DU based on the status change and sending a confirmation of the reconfiguration to the CU.
19. In yet another embodiment, a non-transitory computer readable medium including instructions stored thereon that when processed by at least one processor, cause a Centralized Unit (CU) of a Next Generation Radio Access Network (NG-RAN) to perform operations comprising receiving a notification indicating a change in serving cell due to L1/L2 triggered mobility (LTM) for a UE, from a serving Distributed Unit (DU) of the UE in the NG-RAN. Further, the instructions cause the processor to determine a status change of one or more cells of the serving DU and one or more candidate/target cells of a candidate/target DU amongst a plurality of candidate/target DU upon changing the serving cell for the UE to a new serving cell. The new serving cell is one of the one or more candidate/target cells of a candidate/target DU. Thereafter, the instructions cause the processor to send a message comprising the status change information of all the candidate/target cells including their corresponding cell identifiers to the new serving DU. Content of the message is further transmitted to the UE by the new serving DU. Finally, the instructions cause the processor to receive a confirmation of reconfiguration corresponding to the status change at the new serving DU and the UE. The UE applies one or more configuration changes provided by the CU prior to the change in the serving cell, as part of the reconfiguration.
20. In yet another embodiment, a non-transitory computer readable medium including instructions stored thereon that when processed by at least one processor, cause a User Equipment (UE) to perform operations comprising receiving a notification indicating change in a serving cell, from a serving Distributed Unit (DU) of a Next Generation Radio Access Network (NG-RAN). Further, the instructions cause the processor to establish a connection with a new serving cell of a new serving DU. The UE confirms the application of new serving cell configuration to Centralized Unit (CU) of the RAN upon establishing a successful connection with the new serving cell. Thereafter, the instructions cause the processor to receive a message comprising status change of a one or more candidate/target cells of the new serving DU and all the candidate/target DU from the CU through the new serving DU, when the serving cell for the UE is changed to the new serving cell of the new serving DU. Finally, the instructions cause the processor to perform one or more configuration changes corresponding to the status change as part of reconfiguration, and send a confirmation of the reconfiguration to the CU. The one or more configuration changes are received from the CU prior to the change in the serving cell.
21. In yet another embodiment, a non-transitory computer readable medium including instructions stored thereon that when processed by at least one processor, cause a new serving Distributed Unit (DU) to perform operations comprising receiving a connection establishment from a User Equipment (UE) after changing a serving cell to a new serving cell belonging to a new serving DU. Further, the instructions cause the processor to receive a message comprising status change of a one or more of cells of the candidate/target DU and the new serving DU, from the CU, when the serving cell for the UE is changed to the new serving cell, and transmitting the content of the message from the CU to the UE using a Layer 1 message or a Layer 2 message. Finally, the instructions cause the processor to perform reconfiguration of the new serving DU based on the status change and sending a confirmation of the reconfiguration to the CU.

### Advantages of the Embodiments of the Present Disclosure are Illustrated Herein

In an embodiment, the proposed method reduces latency. Specifically, the following aspects of the present disclosure help in reducing latency. By providing only the updated list (status change) of intra-DU to inter DU changes to the UE for reconfiguration when the serving cell changes, unlike existing techniques that provide additional information which may not be necessary for reconfiguration. This reduces the amount of data to be transmitted to the UE which in turn reduces network latency. Transmitting the intra-DU to inter DU changes or vice versa to only the new serving DU unlike the existing techniques that transmit to all candidate DU. This reduces the unnecessary interaction between CU and other candidate DU which helps reduces network latency during handovers.

In an embodiment, the proposed method reduces signal consumption: Specifically, according to the present disclosure, the UE receives only the updated list (status change) of intra-DU to inter DU changes upon changing the serving cell. This reduces the signal consumption for the UE. Similarly, as the status change is sent to only the new serving DU and not the other candidate DU, signal consumption is reduced for the candidate DU.

In an embodiment, the proposed method reduces additional processing. Specifically, according to the present disclosure, as the CU transmits the changes in the intra-DU to inter DU changes or vice versa to only the new serving DU. This avoids additional processing for CU in creating updated lists for all candidate DU and also eliminates the processing for other candidate DU's during reconfiguration, as there is no need to update the status in other candidate DU's.

In an embodiment, the proposed method reduces delay. Specifically, according to the present disclosure, as mentioned in above points, the CU provides only status change information to UE and UE updates only the changes indicated by the CU in the RRC message while performing reconfiguration corresponding to the status change. Hence, there is reduced delay in data transmission, and subsequent mobility of the UE. Also, since the other candidate DU that are not involved in receiving reconfiguration messages or in performing reconfiguration, this as well reduces the delay in subsequent mobility of the UE.

As stated above, it shall be noted that the method of the present disclosure may be used to overcome various technical problems related to handling of candidate cell reconfiguration of serving/candidate of Distributed Unit (DU) and User Equipment (UE) due to intra-DU to inter-DU status change. In other words, the disclosed method has a practical application and provides a technically advanced solution to the technical problems associated with the existing approach into handling of candidate cell reconfiguration of serving/candidate Distributed Unit (DU) and User Equipment (UE) due to intra-DU to inter-DU status change.

In light of the technical advancements provided by the disclosed method, the claimed steps, as discussed above, are not routine, conventional, or well-known aspects in the art, as the claimed steps provide the aforesaid solutions to the technical problems existing in the conventional technologies. Further, the claimed steps clearly bring an improvement in the functioning of the system itself, as the claimed steps provide a technical solution to a technical problem.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be clear that more than one device/article (whether they cooperate) may be used in place of a single device/article. Similarly, where more than one device/article is described herein (whether they cooperate), it will be clear that a single device/article may be used in place of the more than one device/article or a different number of devices/articles may be used instead of the shown number of devices or programs. The functionality and/or features of a device may be alternatively embodied by one or more other devices which are not explicitly described as having such functionality/features. Thus, other embodiments of invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present disclosure are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Referral Numerals:

| Reference Number | Description |
|---|---|
| 100 | Environment |
| 101 | Next Generation Node B (gNB) |
| 103 | Centralized Unit |
| 105 | Next Generation Node B-Control Unit-Control |
| | Plane (gNB-CU-CP) |
| 107₁-107_{N} | Distributed Unit |
| 109 | Next Generation Node B-Control Unit-User |
| | Plane (gNB-CU-UP) |
| 201 | I/O Interface of CU |
| 203 | Processor of CU |
| 205 | Memory of CU |
| 207 | Data of CU |
| 209 | Modules of CU |
| 211 | Cell data of CU |
| 213 | Configuration data of CU |
| 215 | Other data of CU |
| 217 | Transceiver module |
| 219 | Determining module |
| 221 | Other modules |
| 231 | User Equipment (UE) |
| 233 | I/O Interface of UE |
| 235 | Processor of UE |
| 237 | Memory of UE |
| 239 | Data of UE |
| 241 | Modules of UE |
| 243 | Cell data of UE |
| 245 | Configuration data of UE |
| 247 | Other data of UE |
| 249 | Transceiver module of UE |
| 251 | Configuring module of UE |
| 253 | Other modules of UE |
| 261 | I/O Interface of DU |
| 263 | Processor of DU |
| 265 | Memory of DU |
| 267 | Data of DU |
| 269 | Modules of DU |
| 271 | Cell data of DU |
| 273 | Other data of DU |
| 275 | Receiving module of DU |
| 277 | Configuring module of DU |
| 279 | Other modules of DU |
| 301₁-301_{N} | One or more cells hosted by DU 107₁ |
| 303₁-303_{N} | One or more cells hosted by DU 107₂ |
| 305₁-305_{N} | One or more cells hosted by DU 107₃ |

1. A Centralized Unit (CU) (103) of a Next Generation Radio Access Network (NG-RAN node) comprising:
a processor; and
a memory, communicatively coupled to the processor, wherein the memory stores processor-executable instructions, which, on execution, causes the processor to:
receive a notification indicating a change in serving cell due to L1/L2 triggered mobility (LTM) for a User Equipment (UE), from a serving Distributed Unit (DU) of the UE in the NG-RAN;
determine a status change of one or more cells of the serving DU and one or more candidate/target cells of a candidate/target DU amongst a plurality of candidate/target DU upon changing the serving cell for the UE to a new serving cell, wherein the new serving cell is one of the one or more candidate/target cells of a candidate/target DU;
send a message comprising the status change information of all the candidate/target cells including their corresponding cell identifiers to the new serving DU, wherein content of the message is further transmitted to the UE by the new serving DU; and
receive a confirmation of reconfiguration corresponding to the status change at the new serving DU and the UE, wherein the UE applies one or more configuration changes provided by the CU prior to the change in the serving cell, as part of the reconfiguration.

2. The CU as claimed in claim 1, wherein to determine the status change, the processor is configured to:
determine a change in state of each of the one or more cells of the serving DU and each of the one or more candidate/target cells of the candidate/target DU from intra-DU to inter-DU or inter-DU to intra-DU, based on the change in the UE's serving cell.

3. The CU as claimed in claim 1, wherein prior to receiving the notification, the processor is configured to:
detect one or more candidate/target DUs among plurality of DUs based on a first measurement report received from the UE, wherein each of the one or more candidate/target DUs comprise the one or more candidate/target cells;
transmit a setup request or modification request, requesting preparation of a LTM target cell configuration, to each of the one or more candidate/target DUs detected based on the first measurement report; and
transmit the one or more configuration changes corresponding to the status change to be performed by the UE as part of the reconfiguration to the serving DU, upon receiving LTM candidate cell configurations from each of the one or more candidate/target DUs.

4. The CU as claimed in claim 3, wherein the one or more configuration changes are provided to the UE using a Radio Resource Control (RRC) configuration message.

5. The CU as claimed in claim 1, wherein to send the message comprising the status change, the processor is configured to:
broadcast the serving cell change notification message to each of one or more candidate/target DUs detected by the CU based on a first measurement report received from the UE; and
receive a reconfiguration information corresponding to the status change for each of the candidate/target cells, from each of the one or more candidate/target DUs.

6. The CU as claimed in claim 1, wherein the notification received from the serving DU comprises an Identification Number of the new serving cell of the new serving DU among one or more candidate/target DUs determined for serving the UE.

7. (canceled)

8. (canceled)

9. (canceled)

10. A method comprising:
receiving, by a Centralized Unit (CU) of a Next Generation Radio Access Network (NG-RAN node), a notification indicating a change in serving cell due to L1/L2 triggered mobility (LTM) for a User Equipment (UE), from a serving Distributed Unit (DU) of the UE in the NG-RAN;
determining, by the CU, a status change of one or more cells of the serving DU and one or more candidate/target cells of a candidate/target DU amongst a plurality of candidate/target DU upon changing the serving cell for the UE to a new serving cell, wherein the new serving cell is one of the one or more candidate/target cells of a candidate/target DU;
sending, by the CU, a message comprising the status change information of all the candidate/target cells including their corresponding cell identifiers to the new serving DU, wherein the message content is further transmitted to the UE by the new serving DU; and
receiving, by the CU, a confirmation of reconfiguration corresponding to the status change at the new serving DU and the UE, wherein the UE applies one or more configuration changes provided by the CU prior to the change in the serving cell, as part of the reconfiguration.

11. The method as claimed in claim 10, wherein determining the status change comprises:
determining, by the CU, a change in state of each of the one or more cells of the serving DU and each of the one or more candidate/target cells of the candidate/target DU from intra-DU to inter-DU or inter-DU to intra-DU, based on the change in the UE's serving cell.

12. The method as claimed in claim 10, wherein prior to receiving the notification, the method comprises:
detecting, by the CU, one or more candidate/target DUs among plurality of DUs based on a first measurement report received from the UE, wherein each of the one or more candidate/target DUs comprise the one or more candidate/target cells;
transmitting, by the CU, a setup request or modification request, requesting preparation of a LTM target cell configuration, to each of the one or more candidate/target DUs detected based on the first measurement report; and
transmitting, by the CU, the one or more configuration changes corresponding to the status change to be performed by the UE as part of the reconfiguration to the serving DU, upon receiving LTM candidate cell configurations from each of the one or more candidate/target DUs.

13. The method as claimed in claim 12, wherein the one or more configuration changes are provided to the UE using a Radio Resource Control (RRC) configuration message.

14. The method as claimed in claim 10, wherein sending the message comprising the status change further comprises:
broadcasting, by the CU, the serving cell change notification message to each of one or more candidate/target DUs detected by the CU based on a first measurement report received from the UE; and
receiving, by the CU, a reconfiguration information corresponding to the status change for each of the candidate/target cells, from each of the one or more candidate/target DUs.

15. The method as claimed in claim 10, wherein the notification received from the serving DU comprises an Identification Number of the new serving cell of the new serving DU among one or more candidate/target DUs determined for serving the UE.

16. (canceled)

17. (canceled)

18. (canceled)

19. A non-transitory computer readable medium including instructions stored thereon that when processed by at least one processor, cause a Centralized Unit (CU) to perform operations comprising:
receiving, by a Centralized Unit (CU) of a Next Generation Radio Access Network (NG-RAN node), a notification indicating a change in serving cell due to L1/L2 triggered mobility (LTM) for a User Equipment (UE), from a serving Distributed Unit (DU) of the NG-RAN;
determining, by the CU, a status change of one or more cells of the serving DU and one or more candidate/target cells of a candidate/target DU amongst a plurality of candidate/target DU upon changing the serving cell for the UE to a new serving cell, wherein the new serving cell is one of the one or more candidate/target cells of a candidate/target DU;
sending, by the CU, a message comprising the status change information of all the candidate/target cells including their corresponding cell identifiers to the new serving DU, wherein the message content is further transmitted to the UE by the new serving DU; and
receiving, by the CU, a confirmation of reconfiguration corresponding to the status change at the new serving DU and the UE, wherein the UE applies one or more configuration changes provided by the CU prior to the change in the serving cell, as part of the reconfiguration.

20. (canceled)

21. (canceled)

22. The CU as claimed in claim 5, wherein to broadcast the serving cell change notification message to each of one or more candidate/target DUs, the processor is configured to:
broadcast to each of one or more candidate/target DUs a context modification request message with an updated intra-DU and inter-DU change list.

23. The method as claimed in claim 14, wherein the broadcasting the serving cell change notification message to each of one or more candidate/target DUs, further includes:
broadcasting to each of the one or more candidate/target DUs a context modification request message with an updated intra-DU and inter-DU change list.

24. The non-transitory computer readable medium as claimed in claim 19, wherein determining the status change comprises:
determining, by the CU, a change in state of each of the one or more cells of the serving DU and each of the one or more candidate/target cells of the candidate/target DU from intra-DU to inter-DU or inter-DU to intra-DU, based on the change in the UE's serving cell.

25. The non-transitory computer readable medium as claimed in claim 19, wherein prior to receiving the notification:
detecting, by the CU, one or more candidate/target DUs among plurality of DUs based on a first measurement report received from the UE, wherein each of the one or more candidate/target DUs comprise the one or more candidate/target cells;
transmitting, by the CU, a setup request or modification request, requesting preparation of a LTM target cell configuration, to each of the one or more candidate/target DUs detected based on the first measurement report; and
transmitting, by the CU, the one or more configuration changes corresponding to the status change to be performed by the UE as part of the reconfiguration to the serving DU, upon receiving LTM candidate cell configurations from each of the one or more candidate/target DUs.

26. The non-transitory computer readable medium as claimed in claim 25, wherein the one or more configuration changes are provided to the UE using a Radio Resource Control (RRC) configuration message.

27. The non-transitory computer readable medium as claimed in claim 19, wherein sending the message comprising the status change further comprises:
broadcasting, by the CU, the serving cell change notification message to each of one or more candidate/target DUs detected by the CU based on a first measurement report received from the UE; and
receiving, by the CU, a reconfiguration information corresponding to the status change for each of the candidate/target cells, from each of the one or more candidate/target DUs.

28. The non-transitory computer readable medium as claimed in claim 19, wherein the notification received from the serving DU comprises an Identification Number of the new serving cell of the new serving DU among one or more candidate/target DUs determined for serving the UE.
